(19) United States
(12) Patent Application Publication
(10) Pub. No.: US 2023/0284618 A1
(43) Pub. Date: Sep. 14, 2023

(54) HERBICIDAL COMBINATIONS

(71) Applicants: UPL Corporation Limited, Port Louis (MU); UPL Europe LTD, Warrington (GB)

(72) Inventors: Chad Effertz, Minot, ND (US); Cody Gray, Peyton, CO (US)

(21) Appl. No.: 18/102,848

(22) Filed: Jan. 30, 2023

Related U.S. Application Data
(60) Provisional application No. 63/304,922, filed on Jan. 31, 2022.

(51) Int. Cl. A01N 43/54; A01N 43/50; A01N 33/18; A01P 13/00

(52) U.S. Cl. CPC A01N 43/54; A01N 33/18; A01N 43/50; A01P 13/00

(57) ABSTRACT

Herbicidal combinations for controlling growth of weeds in plants. The present disclosure also relates to a herbicidal compositions comprising the herbicidal combinations, and to methods for controlling growth of weeds by applying the herbicidal combinations to said plant or to a locus thereof.

### CROSS REFERENCE TO RELATED APPLICATIONS

The present application claims the benefit of U.S. Provisional Pat. Application No. 63/304,922 filed on Jan. 31, 2022, which is incorporated by reference herein in its entirety.

### BACKGROUND

The present disclosure relates to a herbicidal combination for controlling growth of weeds. The present disclosure also relates to a herbicidal composition comprising the herbicidal combinations, and to a method for controlling growth of weeds by applying the herbicidal combinations to said plant or to a locus thereof.

Herbicides are chemical substances, which are used to specifically control the weeds in plants. The mode of action for herbicides is a biochemical or a physical mechanism, which it uses to control weeds. There are certain species of weeds or groups of weeds, which are not susceptible to certain herbicides. This may be because either the herbicides use different biochemical pathways, or the herbicides have slightly different enzymes. Herbicides are often chosen for use based on their mode of action. In situations, when one herbicide is ineffective, another herbicide with a different mode of action may provide better results. For this reason, there is a constant need to develop effective herbicidal combinations to control the growth of weeds in various types of plants.

Therefore, herbicides play an important role in agricultural practices, as well as in usage for non-crop land, forests and orchards across the world by helping in removal of unwanted plants/weeds, which contaminate the yielding lands. They also help to overcome the challenges involved with manual weeding in such places.

Further, combinations of herbicides are used, among other purposes, to control a broader range of weeds, and to have lower rates of application as compared to using applications of herbicides individually. However, the combination of herbicides may not always result in achieving the desired effect. Combination of herbicides may lead to an additive effect or an antagonistic effect. It may also result in phytotoxicity to the plants making it an undesirable combination. It is, therefore, necessary to use selective herbicidal combinations which are capable of controlling growth of weed in plants.

At present, a large number of herbicidal combinations have been developed and used, but it is not always possible to control weeds in plants. Furthermore, cases of herbicide-resistant weeds have become increasingly common. Thus, there remains a need for new herbicidal combinations and methods of controlling growth of weeds in plants.

### BRIEF SUMMARY

It is a primary objective of the present disclosure to provide a herbicidal combination comprising at least one hydroxyphenyl pyruvate dioxygenase (HPPD) inhibitor herbicide, at least one microtubule assembly inhibitor herbicide and at least one acetolactate synthase (ALS) inhibitor herbicide, also known as acetohydroxyacid synthase (AHAS) inhibitor herbicide.

It is yet another objective of the present disclosure to provide a herbicidal composition comprising at least one HPPD inhibitor herbicide, at least one microtubule assembly inhibitor herbicide and at least one AHAS inhibitor herbicide.

It is another objective of the present disclosure to provide use of a herbicidal combination comprising at least one HPPD inhibitor herbicide, at least one microtubule assembly inhibitor herbicide and at least one AHAS inhibitor herbicide, for the control of weeds in plants.

It is another objective of the present disclosure to provide a method for controlling growth weeds in plants, said method comprising applying a herbicidal combination to said plant or to a locus thereof.

It is yet another objective of the present disclosure to provide a method for overcoming resistance of weeds in plants, said method comprising applying a herbicidal combination to said plant or to a locus thereof.

It is yet another objective of the present disclosure to provide a method for reducing phytotoxicity in plants, said method comprising applying a herbicidal combination to said plant or to a locus thereof.

It is a primary objective of the present disclosure to provide a herbicidal combination comprising at least one hydroxyphenyl pyruvate dioxygenase (HPPD) inhibitor herbicide, at least one microtubule assembly inhibitor herbicide and at least one acetolactate synthase (ALS) inhibitor herbicide, also known as acetohydroxyacid synthase (AHAS) inhibitor herbicide.

It is yet another objective of the present disclosure to provide a herbicidal composition comprising at least one HPPD inhibitor herbicide, at least one microtubule assembly inhibitor herbicide and at least one AHAS inhibitor herbicide.

It is another objective of the present disclosure to provide use of a herbicidal combination comprising at least one HPPD inhibitor herbicide, at least one microtubule assembly inhibitor herbicide and at least one AHAS inhibitor herbicide, for the control of weeds in plants.

It is another objective of the present disclosure to provide a method for controlling growth weeds in plants, said method comprising applying a herbicidal combination to said plant or to a locus thereof.

It is yet another objective of the present disclosure to provide a method for overcoming resistance of weeds in plants, said method comprising applying a herbicidal combination to said plant or to a locus thereof.

It is yet another objective of the present disclosure to provide a method for reducing phytotoxicity in plants, said method comprising applying a herbicidal combination to said plant or to a locus thereof.

In one aspect of the present disclosure, the disclosure provides a herbicidal combination comprising at least one HPPD inhibitor herbicide, at least one microtubule assembly inhibitor herbicide, and at least one AHAS inhibitor herbicide.

In yet another aspect, the present disclosure provides a herbicidal composition including at least one HPPD inhibitor herbicide, at least one microtubule assembly inhibitor herbicide and at least one AHAS inhibitor herbicide.

In another aspect, the present disclosure provides use of a herbicidal combination including at least one HPPD inhibitor, at least one microtubule assembly inhibitor and at least one AHAS inhibitor for the control of weeds in plants.

In another aspect, the present disclosure provides a method for controlling growth weeds, said method comprising applying to said plant or to a locus thereof a herbicidal combination including at least one HPPD inhibitor herbicide, at least one microtubule assembly inhibitor herbicide and at least one AHAS inhibitor herbicide.

Additional features and advantages of the present disclosure will be apparent from the detailed description that follows, which illustrates by way of example, the most preferred features of the present disclosure which are not to be construed as limiting the scope of the disclosure described herein.

### DETAILED DESCRIPTION

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the disclosure, suitable methods and materials are described herein.

It must be noted that, as used in this specification, the singular forms “a,” “an” and “the” include plural referents unless the content clearly dictates otherwise. The terms first, second etc., as used herein are not meant to denote any particular ordering, but simply for convenience to denote a plurality of, for example, layers. The terms “preferred” and “preferably” refer to embodiments of the disclosure that may afford certain benefits, under certain circumstances.

As used herein, the terms “comprising” “including,” “having,” “containing,” “involving,” and the like are to be understood to be open-ended, i.e., to mean including but not limited to.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ± 10% or ± 5% of the stated value.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

While the disclosure has been described with reference to an exemplary embodiment, it will be understood by those skilled in the art that various changes may be made, and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure is not limited to the particular embodiment disclosed as the best mode contemplated for carrying out this disclosure, but that the disclosure will include all embodiments falling within the scope of the appended claims.

The expression of various quantities in terms of “%” or “% w/v” or “% w/w” means the percentage by weight of the total solution or composition unless otherwise specified.

The term “agrochemical” used herein is understood to denote an agricultural chemical such as pesticides, fungicides, insecticides, acaricides, herbicides, nematicides, plant growth regulators and can be used interchangeably.

The salts referred to herein are agrochemically acceptable salts. As used herein, an “agrochemically acceptable salt” means a salt which is acceptable for use in agrochemical or horticultural use.

As used herein, the term “agrochemical combination” refers to a mixture of more than one component mixed and intended to be applied onto plants with and without further dilution.

The term “herbicide” as used herein denotes a compound which controls or modifies the growth of undesired weeds/plants.

The term “herbicidally effective amount” indicates the quantity of such a compound or combination of such compounds which is capable of controlling or modifying effect on the growth of harmful plants/undesired vegetation/weeds. Controlling effects include all deviation from natural development, for example: killing, retardation, leaf burn, albinism, dwarfism, etc.

As used herein, the term “pre-emergence” refers to the time point before seedlings emerge from the ground. When any herbicide is applied at pre-emergence stage, it prevents establishment of the germinated weed seedlings.

As used herein, the term “post-emergence” refers to the time point after seedlings emerge from the ground. When any herbicide is applied at post-emergence stage, it prevents growth of the germinated weed seedlings.

As used herein the term “plant” or “crop” refers to whole plants, plant organs (e.g., leaves, stems, twigs, roots, trunks, limbs, shoots, fruits etc.), plant cells, or plant seeds. This term also encompasses plant crops such as fruits. The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

The term “locus” refers to an area of planted crops or a location where the weeds occur or grows or can occur or grow and is intended to include soil, medium of growth other than soil. The term “locus” as used herein shall denote the vicinity of a desired crop in which control of the spread of weeds is desired. The locus includes the vicinity of desired crop plants wherein the weeds have either emerged or are most likely to emerge or is yet to emerge.

The term “plant propagation material” refers to the parts of the plant, such as seeds, which can be used for the propagation of the plant and vegetative plant material. There may be mentioned, e.g., the seeds (in the strict sense), roots, fruits, tubers, bulbs, rhizomes as parts of plants. Germinated plants or young plants, which may be transplanted after germination or after emergence from the soil, are included herein.

The term “seed” embraces seeds and plant propagules of all kinds including but not limited to true seeds, seed pieces, suckers, corms, bulbs, fruit, tubers, grains, cuttings, cut shoots and the like. In a preferred embodiment a seed is a true seed.

The term “herbicidal” refers to the ability of a substance to decrease or inhibit growth of weeds.

The term “control” or “controlling” weeds includes to inhibit, and/or suppress the ability of weeds to grow and/or reproduce, or to limit weeds’ damage or loss in crop plants. Controlling effects include all deviation from natural development, for example: killing and retardation. The term “control” relates to a weed, includes control of the weed, as well as protecting a plant, a portion of the plant, or a plant seed from attack or invasion by said weed.

As used herein, the term “tank-mix” refers to a mixture of more than one component mixed in tanks and intended to be applied onto plants with/without further dilution with water to make a mixture.

The term “increased yield” of an agricultural plant means that the yield of a product of the respective plant is increased by a measurable amount over the yield of the same product of the plant produced under the same conditions, but without the application of the compositions described herein. According to the present disclosure, it is preferred that the crop yield be increased by at least 0.5 %, preferably at least 2%, more preferably at least 5%, upon application of the combinations and compositions described herein. The composition also increases the vigour/yield of the plant.

In an embodiment, the present disclosure provides an agrochemical combination.

Accordingly in an embodiment, the present disclosure provides a herbicidal combination.

In another embodiment, the present disclosure provides a herbicidal combination comprising:
(a) at least one HPPD inhibitor herbicide;
(b) at least one microtubule assembly inhibitor herbicide; and
(c) at least one AHAS inhibitor herbicide.

As used throughout the disclosure, the HPPD inhibitor herbicide or other active ingredients, for example, the microtubule assembly inhibitor herbicide or the AHAS inhibitor herbicide, include their salts, esters, ethers, and polymorphs including solvates and hydrates. A salt includes salts that retain the biological effectiveness and properties of the active ingredient, and which are not biologically or otherwise undesirable, and includes derivatives of the disclosed compounds in which the parent compound is modified by making inorganic and organic, non-toxic, acid or base addition salts thereof. The salts can be synthesized from the parent compound by conventional chemical methods.

In another embodiment, the hydroxyphenyl pyruvate dioxygenase (HPPD) is an enzyme that breaks down the amino acid tyrosine into components that are used to create other important molecules. The HPPD inhibitor herbicides block the enzyme and stunt plant growth, causing oxidative damage to the plant and destroy chlorophyll.

In another embodiment, the microtubule assembly inhibitor herbicides are mitotic poisons that inhibit cell division, thus affecting the meristematic regions, such as the growing points of stems and roots, the most.

In another embodiment, the acetohydroxyacid synthase (AHAS) also referred to herein as acetolactate synthase (ALS), is a key enzyme in the pathway of biosynthesis of branched-chain amino acids such as isoleucine, leucine, and valine. The AHAS inhibitor herbicides cause inhibition of the biosynthesis of branched-chain amino acids.

In an embodiment, the HPPD inhibitor herbicide comprises isoxaflutole, pyrasulfotole, tolpyralate, topramezone, benzofenap, pyrazolynate, pyrazoxyfen, bicyclopyrone, fenquinotrione, mesotrione, sulcotrione, tefuryltrione, tembotrione, benzobicyclon, or combinations thereof.

According to another embodiment, the HPPD inhibitor herbicide is mesotrione.

In an embodiment, the microtubule assembly inhibitor herbicide comprises propyzamide/pronamide, chlorthaldimethyl/dimethyl tetrachloroterephthale (DCPA), benefin/benfluralin, butralin, dinitramine, ethalfluralin, fluchloralin, isopropalin, nitralin, oryzalin, pendimethalin, prodiamine, profluralin, trifluralin, butamifos, O-(2,4-dichlorophenyl) O-methyl isopropylphosphoramidothioate (DMPA), dithiopyr, thiazopyr, or combinations thereof.

According to another embodiment, the microtubule assembly inhibitor herbicide is pendimethalin.

In an embodiment, the ALS/AHAS inhibitor herbicide comprises imazamethabenz-methyl, imazamox, imazapic, imazapyr, imazaquin, imazethapyr, bispyribac-sodium, pyribenzoxim (prodrug of bispyribac), pyriftalid, pyriminobac-methyl, pyrithiobac-sodium, pyrimisulfan, triafamone, amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flucetosulfuron, flupyrsulfuron-methyl-sodium, foramsulfuron, halosulfuron-methyl, imazosulfuron, iodosulfuron-methyl- sodium, mesosulfuron-methyl, metazosulfuron, metsulfuron-methyl, nicosulfuron, orthosulfamuron, oxasulfuron, primisulfuron-methyl, propyrisulfuron, prosulfuron, pyrazosulfuron-ethyl, rimsulfuron, sulfometuron-methyl, sulfosulfuron, thifensulfuron-methyl, triasulfuron, tribenuron-methyl, trifloxysulfuron-na, triflusulfuron-methyl, tritosulfuron, flucarbazone- sodium, propoxycarbazone-na, thiencarbazone-methyl, cloransulam-methyl, diclosulam, florasulam, flumetsulam, metosulam, penoxsulam, pyroxsulam or combinations thereof.

According to another embodiment, the AHAS inhibitor herbicide is imazamox.

According to another embodiment, the AHAS inhibitor herbicide is rimsulfuron.

According to another embodiment, in the present disclosure, for the sake of brevity, the HPPD inhibitor herbicides are sometimes referred to by corresponding short references as mentioned in Table 1.

TABLE 1

List of the HPPD inhibitor herbicides

| Sr. No. | HPPD Inhibitor Herbicides | Short reference |
|---|---|---|
| 1 | Isoxaflutole | A (1) |
| 2 | Pyrasulfotole | A (2) |
| 3 | Tolpyralate | A (3) |
| 4 | Topramezone | A (4) |
| 5 | Benzofenap | A (5) |
| 6 | Pyrazolynate | A (6) |
| 7 | Pyrazoxyfen | A (7) |
| 8 | Bicyclopyrone | A (8) |
| 9 | Fenquinotrione | A (9) |
| 10 | Mesotrione | A (10) |
| 11 | Sulcotrione | A (11) |
| 12 | Tefuryltrione | A (12) |
| 13 | Tembotrione | A (13) |
| 14 | Benzobicyclon | A (14) |

According to another embodiment, in the present disclosure, for the sake of brevity, the microtubule assembly inhibitor herbicides are sometimes referred to by corresponding short references as mentioned in Table 2.

TABLE 2

List of the microtubule assembly inhibitor herbicides

| Sr. No. | Microtubule Assembly Inhibitor Herbicide | Short reference |
|---|---|---|
| 1 | Propyzamide (aka pronamide) | B (1) |
| 2 | Chlorthal-dimethyl (aka DCPA) | B (2) |
| 3 | Benefin (aka benfluralin) | B (3) |
| 4 | Butralin | B (4) |
| 5 | Dinitramine | B (5) |
| 6 | Ethalfluralin | B (6) |
| 7 | Fluchloralin | B (7) |
| 8 | Isopropalin | B (8) |
| 9 | Nitralin | B (9) |
| 10 | Oryzalin | B (10) |
| 11 | Pendimethalin | B (11) |
| 12 | Prodiamine | B (12) |
| 13 | Profluralin | B (13) |
| 14 | Trifluralin | B (14) |
| 15 | Butamifos | B (15) |
| 16 | DMPA | B (16) |
| 17 | Dithiopyr | B (17) |
| 18 | Thiazopyr | B (18) |

According to another embodiment, in the present disclosure, for the sake of brevity, the ALS/AHAS inhibitor herbicides are sometimes referred to by corresponding short references as mentioned in Table 3.

TABLE 3

List of the AHAS inhibitor herbicides

| Sr. No. | ALS/AHAS Inhibitor Herbicides | Short reference |
|---|---|---|
| 1 | Imazamethabenz-methyl | C (1) |
| 2 | Imazamox | C (2) |
| 3 | Imazapic | C (3) |
| 4 | Imazapyr | C (4) |
| 5 | Imazaquin | C (5) |
| 6 | Imazethapyr | C (6) |
| 7 | Bispyribac-sodium | C (7) |
| 8 | Pyribenzoxim (prodrug of bispyribac) | C (8) |
| 9 | Pyriftalid | C (9) |
| 10 | Pyriminobac-methyl | C (10) |
| 11 | Pyrithiobac-sodium | C (11) |
| 12 | Pyrimisulfan | C (12) |
| 13 | Triafamone | C (13) |
| 14 | Amidosulfuron | C (14) |
| 15 | Azimsulfuron | C (15) |
| 16 | Bensulfuron-methyl | C (16) |
| 17 | Chl orimuron-ethyl | C (17) |
| 18 | Chlorsulfuron | C (18) |
| 19 | Cinosulfuron | C (19) |
| 20 | Cyclosulfamuron | C (20) |
| 21 | Ethametsulfuron-methyl | C (21) |
| 22 | Ethoxysulfuron | C (22) |
| 23 | Flazasulfuron | C (23) |
| 24 | Flucetosulfuron | C (24) |
| 25 | Flupyrsulfuron-methyl-Na | C (25) |
| 26 | Foramsulfuron | C (26) |
| 27 | Halosulfuron-methyl | C (27) |
| 28 | Imazosulfuron | C (28) |
| 29 | Iodosulfuron-methyl-Na | C (29) |
| 30 | Mesosulfuron-methyl | C (30) |
| 31 | Metazosulfuron | C (31) |
| 32 | Metsulfuron-methyl | C (32) |
| 33 | Nicosulfuron | C (33) |
| 34 | Orthosulfamuron | C (34) |
| 35 | Oxasulfuron | C (35) |
| 36 | Primisulfuron-methyl | C (36) |
| 37 | Propyrisulfuron | C (37) |
| 38 | Prosulfuron | C (38) |
| 39 | Pyrazosulfuron-ethyl | C (39) |
| 40 | Rimsulfuron | C (40) |
| 41 | S ulfometuron-methyl | C (41) |
| 42 | Sulfosulfuron | C (42) |
| 43 | Thifensulfuron-methyl | C (43) |
| 44 | Triasulfuron | C (44) |
| 45 | Tribenuron-methyl | C (45) |
| 46 | Trifloxysulfuron-Na | C (46) |
| 47 | Triflusulfuron-methyl | C (47) |
| 48 | Tritosulfuron | C (48) |
| 49 | Flucarbazone-Na | C (49) |
| 50 | Propoxycarbazone-Na | C (50) |
| 51 | Thiencarbazone-methyl | C (51) |
| 52 | Cloransulam-methyl | C (52) |
| 53 | Diclosulam | C (53) |
| 54 | Florasulam | C (54) |
| 55 | Flumetsulam | C (55) |
| 56 | Metosulam | C (56) |
| 57 | Penoxsulam | C (57) |
| 58 | Pyroxsulam | C (58) |

In another embodiment, Table 4 provides list of some examples of the herbicidal combinations according to the present disclosure.

TABLE 4

Examples of herbicidal combinations

| Sr. No. | AHAS inhibitor herbicides | Microtubule assembly inhibitor herbicide | HPPD inhibitor herbicide |
|---|---|---|---|
| 1 | C (1) | One or more of B (1) to B (18) | A (1) |
| 2 | C (1) | One or more of B (1) to B (18) | A (2) |
| 3 | C (1) | One or more of B (1) to B (18) | A (3) |
| 4 | C (1) | One or more of B (1) to B (18) | A (4) |
| 5 | C (1) | One or more of B (1) to B (18) | A (5) |
| 6 | C (1) | One or more of B (1) to B (18) | A (6) |
| 7 | C (1) | One or more of B (1) to B (18) | A (7) |
| 8 | C (1) | One or more of B (1) to B (18) | A (8) |
| 9 | C (1) | One or more of B (1) to B (18) | A (9) |
| 10 | C (1) | One or more of B (1) to B (18) | A (10) |
| 11 | C (1) | One or more of B (1) to B (18) | A (II) |
| 12 | C (1) | One or more of B (1) to B (18) | A (12) |
| 13 | C (1) | One or more of B (1) to B (18) | A (13) |
| 14 | C (1) | One or more of B (1) to B (18) | A (14) |
| 15 | C (1) | One or more of B (1) to B (18) | One or more of A (1) to A (14) |
| 16 | C(2) | One or more of B (1) to B (18) | A (1) |
| 17 | C(2) | One or more of B (1) to B (18) | A (2) |
| 18 | C (2) | One or more of B (1) to B (18) | A (3) |
| 19 | C (2) | One or more of B (1) to B (18) | A (4) |
| 20 | C (2) | One or more of B (1) to B (18) | A (5) |
| 21 | C (2) | One or more of B (1) to B (18) | A (6) |
| 22 | C (2) | One or more of B (1) to B (18) | A (7) |
| 23 | C (2) | One or more of B (1) to B (18) | A (8) |
| 24 | C (2) | One or more of B (1) to B (18) | A (9) |
| 25 | C (2) | One or more of B (1) to B (18) | A (10) |
| 26 | C (2) | One or more of B (1) to B (18) | A (11) |
| 27 | C (2) | One or more of B (1) to B (18) | A (12) |
| 28 | C (2) | One or more of B (1) to B (18) | A (13) |
| 29 | C (2) | One or more of B (1) to B (18) | A (14) |
| 30 | C (2) | One or more of B (1) to B (18) | One or more of A (1) to A (14) |
| 31 | C (3) | One or more of B (1) to B (18) | A (1) |
| 32 | C (3) | One or more of B (1) to B (18) | A (2) |
| 33 | C (3) | One or more of B (1) to B (18) | A (3) |
| 34 | C (3) | One or more of B (1) to B (18) | A (4) |
| 35 | C (3) | One or more of B (1) to B (18) | A (5) |
| 36 | C (3) | One or more of B (1) to B (18) | A (6) |
| 37 | C (3) | One or more of B (1) to B (18) | A (7) |
| 38 | C (3) | One or more of B (1) to B (18) | A (8) |
| 39 | C (3) | One or more of B (1) to B (18) | A (9) |
| 40 | C (3) | One or more of B (1) to B (18) | A (10) |
| 41 | C (3) | One or more of B (1) to B (18) | A (11) |
| 42 | C (3) | One or more of B (1) to B (18) | A (12) |
| 43 | C (3) | One or more of B (1) to B (18) | A (13) |
| 44 | C (3) | One or more of B (1) to B (18) | A (14) |
| 45 | C (3) | One or more of B (1) to B (18) | One or more of A (1) to A (14) |
| 46 | C (4) | One or more of B (1) to B (18) | A (1) |
| 47 | C (4) | One or more of B (1) to B (18) | A (2) |
| 48 | C (4) | One or more of B (1) to B (18) | A (3) |
| 49 | C (4) | One or more of B (1) to B (18) | A (4) |
| 50 | C (4) | One or more of B (1) to B (18) | A (5) |
| 51 | C (4) | One or more of B (1) to B (18) | A (6) |
| 52 | C (4) | One or more of B (1) to B (18) | A (7) |
| 53 | C (4) | One or more of B (1) to B (18) | A (8) |
| 54 | C (4) | One or more of B (1) to B (18) | A (9) |
| 55 | C (4) | One or more of B (1) to B (18) | A (10) |
| 56 | C (4) | One or more of B (1) to B (18) | A (11) |
| 57 | C (4) | One or more of B (1) to B (18) | A (12) |
| 58 | C (4) | One or more of B (1) to B (18) | A (13) |
| 59 | C (4) | One or more of B (1) to B (18) | A (14) |
| 60 | C (4) | One or more of B (1) to B (18) | One or more of A (1) to A (14) |
| 61 | C (5) | One or more of B (1) to B (18) | A (1) |
| 62 | C (5) | One or more of B (1) to B (18) | A (2) |
| 63 | C (5) | One or more of B (1) to B (18) | A (3) |
| 64 | C (5) | One or more of B (1) to B (18) | A (4) |
| 65 | C (5) | One or more of B (1) to B (18) | A (5) |
| 66 | C (5) | One or more of B (1) to B (18) | A (6) |
| 67 | C (5) | One or more of B (1) to B (18) | A (7) |
| 68 | C (5) | One or more of B (1) to B (18) | A (8) |
| 69 | C (5) | One or more of B (1) to B (18) | A (9) |
| 70 | C (5) | One or more of B (1) to B (18) | A (10) |
| 71 | C (5) | One or more of B (1) to B (18) | A (11) |
| 72 | C (5) | One or more of B (1) to B (18) | A (12) |
| 73 | C (5) | One or more of B (1) to B (18) | A (13) |
| 74 | C (5) | One or more of B (1) to B (18) | A (14) |
| 75 | C (5) | One or more of B (1) to B (18) | One or more of A (1) to A (14) |
| 76 | C (6) | One or more of B (1) to B (18) | A (1) |
| 77 | C (6) | One or more of B (1) to B (18) | A (2) |
| 78 | C (6) | One or more of B (1) to B (18) | A (3) |
| 79 | C (6) | One or more of B (1) to B (18) | A (4) |
| 80 | C (6) | One or more of B (1) to B (18) | A (5) |
| 81 | C (6) | One or more of B (1) to B (18) | A (6) |
| 82 | C (6) | One or more of B (1) to B (18) | A (7) |
| 83 | C (6) | One or more of B (1) to B (18) | A (8) |
| 84 | C (6) | One or more of B (1) to B (18) | A (9) |
| 85 | C (6) | One or more of B (1) to B (18) | A (10) |
| 86 | C (6) | One or more of B (1) to B (18) | A (11) |
| 87 | C (6) | One or more of B (1) to B (18) | A (12) |
| 88 | C (6) | One or more of B (1) to B (18) | A (13) |
| 89 | C (6) | One or more of B (1) to B (18) | A (14) |
| 90 | C (6) | One or more of B (1) to B (18) | One or more of A (1) to A (14) |
| 91 | C (7) | One or more of B (1) to B (18) | A (1) |
| 92 | C (7) | One or more of B (1) to B (18) | A (2) |
| 93 | C (7) | One or more of B (1) to B (18) | A (3) |
| 94 | C (7) | One or more of B (1) to B (18) | A (4) |
| 95 | C (7) | One or more of B (1) to B (18) | A (5) |
| 96 | C (7) | One or more of B (1) to B (18) | A (6) |
| 97 | C (7) | One or more of B (1) to B (18) | A (7) |
| 98 | C (7) | One or more of B (1) to B (18) | A (8) |
| 99 | C (7) | One or more of B (1) to B (18) | A (9) |
| 100 | C (7) | One or more of B (1) to B (18) | A (10) |
| 101 | C (7) | One or more of B (1) to B (18) | A (11) |
| 102 | C (7) | One or more of B (1) to B (18) | A (12) |
| 103 | C (7) | One or more of B (1) to B (18) | A (13) |
| 104 | C (7) | One or more of B (1) to B (18) | A (14) |
| 105 | C (7) | One or more of B (1) to B (18) | One or more of A (1) to A (14) |
| 106 | C (8) | One or more of B (1) to B (18) | A(1) |
| 107 | C (8) | One or more of B (1) to B (18) | A (2) |
| 108 | C (8) | One or more of B (1) to B (18) | A (3) |
| 109 | C (8) | One or more of B (1) to B (18) | A (4) |
| 110 | C (8) | One or more of B (1) to B (18) | A (5) |
| 111 | C (8) | One or more of B (1) to B (18) | A (6) |
| 112 | C (8) | One or more of B (1) to B (18) | A (7) |
| 113 | C (8) | One or more of B (1) to B (18) | A (8) |
| 114 | C (8) | One or more of B (1) to B (18) | A (9) |
| 115 | C (8) | One or more of B (1) to B (18) | A (10) |
| 116 | C (8) | One or more of B (1) to B (18) | A (11) |
| 117 | C (8) | One or more of B (1) to B (18) | A (12) |
| 118 | C (8) | One or more of B (1) to B (18) | A (13) |
| 119 | C (8) | One or more of B (1) to B (18) | A (14) |
| 120 | C (8) | One or more of B (1) to B (18) | One or more of A (1) to A (14) |
| 121 | C (9) | One or more of B (1) to B (18) | A (1) |
| 122 | C (9) | One or more of B (1) to B (18) | A (2) |
| 123 | C (9) | One or more of B (1) to B (18) | A (3) |
| 124 | C (9) | One or more of B (1) to B (18) | A (4) |
| 125 | C (9) | One or more of B (1) to B (18) | A (5) |
| 126 | C (9) | One or more of B (1) to B (18) | A (6) |
| 127 | C (9) | One or more of B (1) to B (18) | A (7) |
| 128 | C (9) | One or more of B (1) to B (18) | A (8) |
| 129 | C (9) | One or more of B (1) to B (18) | A (9) |
| 130 | C (9) | One or more of B (1) to B (18) | A (10) |
| 131 | C (9) | One or more of B (1) to B (18) | A (11) |
| 132 | C (9) | One or more of B (1) to B (18) | A (12) |
| 133 | C (9) | One or more of B (1) to B (18) | A (13) |
| 134 | C (9) | One or more of B (1) to B (18) | A (14) |
| 135 | C (9) | One or more of B (1) to B (18) | One or more of A (1) to A (14) |
| 136 | C (10) | One or more of B (1) to B (18) | A (1) |
| 137 | C (10) | One or more of B (1) to B (18) | A (2) |
| 138 | C (10) | One or more of B (1) to B (18) | A (3) |
| 139 | C (10) | One or more of B (1) to B (18) | A (4) |
| 140 | C (10) | One or more of B (1) to B (18) | A (5) |
| 141 | C (10) | One or more of B (1) to B (18) | A (6) |
| 142 | C (10) | One or more of B (1) to B (18) | A (7) |
| 143 | C (10) | One or more of B (1) to B (18) | A (8) |
| 144 | C (10) | One or more of B (1) to B (18) | A (9) |
| 145 | C (10) | One or more of B (1) to B (18) | A (10) |
| 146 | C (10) | One or more of B (1) to B (18) | A (11) |
| 147 | C (10) | One or more of B (1) to B (18) | A (12) |
| 148 | C (10) | One or more of B (1) to B (18) | A (13) |
| 149 | C (10) | One or more of B (1) to B (18) | A (14) |
| 150 | C (10) | One or more of B (1) to B (18) | One or more of A (1) to A (14) |
| 151 | c (11) | One or more of B (1) to B (18) | A (1) |
| 152 | c (11) | One or more of B (1) to B (18) | A (2) |
| 153 | c (11) | One or more of B (1) to B (18) | A (3) |
| 154 | c (11) | One or more of B (1) to B (18) | A (4) |
| 155 | c (11) | One or more of B (1) to B (18) | A (5) |
| 156 | c (11) | One or more of B (1) to B (18) | A (6) |
| 157 | c (11) | One or more of B (1) to B (18) | A (7) |
| 158 | c (11) | One or more of B (1) to B (18) | A (8) |
| 159 | c (11) | One or more of B (1) to B (18) | A (9) |
| 160 | c (11) | One or more of B (1) to B (18) | A (10) |
| 161 | c (11) | One or more of B (1) to B (18) | A (11) |
| 162 | c (11) | One or more of B (1) to B (18) | A (12) |
| 163 | c (11) | One or more of B (1) to B (18) | A (13) |
| 164 | c (11) | One or more of B (1) to B (18) | A (14) |
| 165 | C (11) | One or more of B (1) to B (18) | One or more of A (1) to A (14) |
| 166 | C (12) | One or more of B (1) to B (18) | A (1) |
| 167 | C (12) | One or more of B (1) to B (18) | A (2) |
| 168 | C (12) | One or more of B (1) to B (18) | A (3) |
| 169 | C (12) | One or more of B (1) to B (18) | A (4) |
| 170 | C (12) | One or more of B (1) to B (18) | A (5) |
| 171 | C (12) | One or more of B (1) to B (18) | A (6) |
| 172 | C (12) | One or more of B (1) to B (18) | A (7) |
| 173 | C (12) | One or more of B (1) to B (18) | A (8) |
| 174 | C (12) | One or more of B (1) to B (18) | A (9) |
| 175 | C (12) | One or more of B (1) to B (18) | A (10) |
| 176 | C (12) | One or more of B (1) to B (18) | A (11) |
| 177 | C (12) | One or more of B (1) to B (18) | A (12) |
| 178 | C (12) | One or more of B (1) to B (18) | A (13) |
| 179 | C (12) | One or more of B (1) to B (18) | A (14) |
| 180 | C (12) | One or more of B (1) to B (18) | One or more of A (1) to A (14) |
| 181 | C (13) | One or more of B (1) to B (18) | A (1) |
| 182 | C (13) | One or more of B (1) to B (18) | A (2) |
| 183 | C (13) | One or more of B (1) to B (18) | A (3) |
| 184 | C (13) | One or more of B (1) to B (18) | A (4) |
| 185 | C (13) | One or more of B (1) to B (18) | A (5) |
| 186 | C (13) | One or more of B (1) to B (18) | A (6) |
| 187 | C (13) | One or more of B (1) to B (18) | A (7) |
| 188 | C (13) | One or more of B (1) to B (18) | A (8) |
| 189 | C (13) | One or more of B (1) to B (18) | A (9) |
| 190 | C (13) | One or more of B (1) to B (18) | A (10) |
| 191 | C (13) | One or more of B (1) to B (18) | A (11) |
| 192 | C (13) | One or more of B (1) to B (18) | A (12) |
| 193 | C (13) | One or more of B (1) to B (18) | A (13) |
| 194 | C (13) | One or more of B (1) to B (18) | A (14) |
| 195 | C (13) | One or more of B (1) to B (18) | One or more of A (1) to A (14) |
| 196 | C (14) | One or more of B (1) to B (18) | A(1) |
| 197 | C (14) | One or more of B (1) to B (18) | A (2) |
| 198 | C (14) | One or more of B (1) to B (18) | A (3) |
| 199 | C (14) | One or more of B (1) to B (18) | A (4) |
| 200 | C (14) | One or more of B (1) to B (18) | A (5) |
| 201 | C (14) | One or more of B (1) to B (18) | A (6) |
| 202 | C (14) | One or more of B (1) to B (18) | A (7) |
| 203 | C (14) | One or more of B (1) to B (18) | A (8) |
| 204 | C (14) | One or more of B (1) to B (18) | A (9) |
| 205 | C (14) | One or more of B (1) to B (18) | A (10) |
| 206 | C (14) | One or more of B (1) to B (18) | A (11) |
| 207 | C (14) | One or more of B (1) to B (18) | A (12) |
| 208 | C (14) | One or more of B (1) to B (18) | A (13) |
| 209 | C (14) | One or more of B (1) to B (18) | A (14) |
| 210 | C (14) | One or more of B (1) to B (18) | One or more of A (1) to A (14) |
| 211 | C (15) | One or more of B (1) to B (18) | A (1) |
| 212 | C (15) | One or more of B (1) to B (18) | A (2) |
| 213 | C (15) | One or more of B (1) to B (18) | A (3) |
| 214 | C (15) | One or more of B (1) to B (18) | A (4) |
| 215 | C (15) | One or more of B (1) to B (18) | A (5) |
| 216 | C (15) | One or more of B (1) to B (18) | A (6) |
| 217 | C (15) | One or more of B (1) to B (18) | A (7) |
| 218 | C (15) | One or more of B (1) to B (18) | A (8) |
| 219 | C (15) | One or more of B (1) to B (18) | A (9) |
| 220 | C (15) | One or more of B (1) to B (18) | A (10) |
| 221 | C (15) | One or more of B (1) to B (18) | A (11) |
| 222 | C (15) | One or more of B (1) to B (18) | A (12) |
| 223 | C (15) | One or more of B (1) to B (18) | A (13) |
| 224 | C (15) | One or more of B (1) to B (18) | A (14) |
| 225 | C (15) | One or more of B (1) to B (18) | One or more of A (1) to A (14) |
| 226 | C (16) | One or more of B (1) to B (18) | A(1) |
| 227 | C (16) | One or more of B (1) to B (18) | A (2) |
| 228 | C (16) | One or more of B (1) to B (18) | A (3) |
| 229 | C (16) | One or more of B (1) to B (18) | A (4) |
| 230 | C (16) | One or more of B (1) to B (18) | A (5) |
| 231 | C (16) | One or more of B (1) to B (18) | A (6) |
| 232 | C (16) | One or more of B (1) to B (18) | A (7) |
| 233 | C (16) | One or more of B (1) to B (18) | A (8) |
| 234 | C (16) | One or more of B (1) to B (18) | A (9) |
| 235 | C (16) | One or more of B (1) to B (18) | A (10) |
| 236 | C (16) | One or more of B (1) to B (18) | A (11) |
| 237 | C (16) | One or more of B (1) to B (18) | A (12) |
| 238 | C (16) | One or more of B (1) to B (18) | A (13) |
| 239 | C (16) | One or more of B (1) to B (18) | A (14) |
| 240 | C (16) | One or more of B (1) to B (18) | One or more of A (1) to A (14) |
| 241 | C (17) | One or more of B (1) to B (18) | A (1) |
| 242 | C (17) | One or more of B (1) to B (18) | A (2) |
| 243 | C (17) | One or more of B (1) to B (18) | A (3) |
| 244 | C (17) | One or more of B (1) to B (18) | A (4) |
| 245 | C (17) | One or more of B (1) to B (18) | A (5) |
| 246 | C (17) | One or more of B (1) to B (18) | A (6) |
| 247 | C (17) | One or more of B (1) to B (18) | A (7) |
| 248 | C (17) | One or more of B (1) to B (18) | A (8) |
| 249 | C (17) | One or more of B (1) to B (18) | A (9) |
| 250 | C (17) | One or more of B (1) to B (18) | A (10) |
| 251 | C (17) | One or more of B (1) to B (18) | A (11) |
| 252 | C (17) | One or more of B (1) to B (18) | A (12) |
| 253 | C (17) | One or more of B (1) to B (18) | A (13) |
| 254 | C (17) | One or more of B (1) to B (18) | A (14) |
| 255 | C (17) | One or more of B (1) to B (18) | One or more of A (1) to A (14) |
| 256 | C (18) | One or more of B (1) to B (18) | A(1) |
| 257 | C (18) | One or more of B (1) to B (18) | A (2) |
| 258 | C (18) | One or more of B (1) to B (18) | A (3) |
| 259 | C (18) | One or more of B (1) to B (18) | A (4) |
| 260 | C (18) | One or more of B (1) to B (18) | A (5) |
| 261 | C (18) | One or more of B (1) to B (18) | A (6) |
| 262 | C (18) | One or more of B (1) to B (18) | A (7) |
| 263 | C (18) | One or more of B (1) to B (18) | A (8) |
| 264 | C (18) | One or more of B (1) to B (18) | A (9) |
| 265 | C (18) | One or more of B (1) to B (18) | A (10) |
| 266 | C (18) | One or more of B (1) to B (18) | A (11) |
| 267 | C (18) | One or more of B (1) to B (18) | A (12) |
| 268 | C (18) | One or more of B (1) to B (18) | A (13) |
| 269 | C (18) | One or more of B (1) to B (18) | A (14) |
| 270 | C (18) | One or more of B (1) to B (18) | One or more of A (1) to A (14) |
| 271 | C (19) | One or more of B (1) to B (18) | A (1) |
| 272 | C (19) | One or more of B (1) to B (18) | A (2) |
| 273 | C (19) | One or more of B (1) to B (18) | A (3) |
| 274 | C (19) | One or more of B (1) to B (18) | A (4) |
| 275 | C (19) | One or more of B (1) to B (18) | A (5) |
| 276 | C (19) | One or more of B (1) to B (18) | A (6) |
| 277 | C (19) | One or more of B (1) to B (18) | A (7) |
| 278 | C (19) | One or more of B (1) to B (18) | A (8) |
| 279 | C (19) | One or more of B (1) to B (18) | A (9) |
| 280 | C (19) | One or more of B (1) to B (18) | A (10) |
| 281 | C (19) | One or more of B (1) to B (18) | A (11) |
| 282 | C (19) | One or more of B (1) to B (18) | A (12) |
| 283 | C (19) | One or more of B (1) to B (18) | A (13) |
| 284 | C (19) | One or more of B (1) to B (18) | A (14) |
| 285 | C (19) | One or more of B (1) to B (18) | One or more of A (1) to A (14) |
| 286 | C (20) | One or more of B (1) to B (18) | A (1) |
| 287 | C (20) | One or more of B (1) to B (18) | A (2) |
| 288 | C (20) | One or more of B (1) to B (18) | A (3) |
| 289 | C (20) | One or more of B (1) to B (18) | A (4) |
| 290 | C (20) | One or more of B (1) to B (18) | A (5) |
| 291 | C (20) | One or more of B (1) to B (18) | A (6) |
| 292 | C (20) | One or more of B (1) to B (18) | A (7) |
| 293 | C (20) | One or more of B (1) to B (18) | A (8) |
| 294 | C (20) | One or more of B (1) to B (18) | A (9) |
| 295 | C (20) | One or more of B (1) to B (18) | A (10) |
| 296 | C (20) | One or more of B (1) to B (18) | A (11) |
| 297 | C (20) | One or more of B (1) to B (18) | A (12) |
| 298 | C (20) | One or more of B (1) to B (18) | A (13) |
| 299 | C (20) | One or more of B (1) to B (18) | A (14) |
| 300 | C (20) | One or more of B (1) to B (18) | One or more of A (1) to A (14) |
| 301 | C (21) | One or more of B (1) to B (18) | A (1) |
| 302 | C (21) | One or more of B (1) to B (18) | A (2) |
| 303 | C (21) | One or more of B (1) to B (18) | A (3) |
| 304 | C (21) | One or more of B (1) to B (18) | A (4) |
| 305 | C (21) | One or more of B (1) to B (18) | A (5) |
| 306 | C (21) | One or more of B (1) to B (18) | A (6) |
| 307 | C (21) | One or more of B (1) to B (18) | A (7) |
| 308 | C (21) | One or more of B (1) to B (18) | A (8) |
| 309 | C (21) | One or more of B (1) to B (18) | A (9) |
| 310 | C (21) | One or more of B (1) to B (18) | A (10) |
| 311 | C (21) | One or more of B (1) to B (18) | A (11) |
| 312 | C (21) | One or more of B (1) to B (18) | A (12) |
| 313 | C (21) | One or more of B (1) to B (18) | A (13) |
| 314 | C (21) | One or more of B (1) to B (18) | A (14) |
| 315 | C (21) | One or more of B (1) to B (18) | One or more of A (1) to A (14) |
| 316 | C (22) | One or more of B (1) to B (18) | A (1) |
| 317 | C (22) | One or more of B (1) to B (18) | A (2) |
| 318 | C (22) | One or more of B (1) to B (18) | A (3) |
| 319 | C (22) | One or more of B (1) to B (18) | A (4) |
| 320 | C (22) | One or more of B (1) to B (18) | A (5) |
| 321 | C (22) | One or more of B (1) to B (18) | A (6) |
| 322 | C (22) | One or more of B (1) to B (18) | A (7) |
| 323 | C (22) | One or more of B (1) to B (18) | A (8) |
| 324 | C (22) | One or more of B (1) to B (18) | A (9) |
| 325 | C (22) | One or more of B (1) to B (18) | A (10) |
| 326 | C (22) | One or more of B (1) to B (18) | A (11) |
| 327 | C (22) | One or more of B (1) to B (18) | A (12) |
| 328 | C (22) | One or more of B (1) to B (18) | A (13) |
| 329 | C (22) | One or more of B (1) to B (18) | A (14) |
| 330 | C (22) | One or more of B (1) to B (18) | One or more of A (1) to A (14) |
| 331 | C (23) | One or more of B (1) to B (18) | A (1) |
| 332 | C (23) | One or more of B (1) to B (18) | A (2) |
| 333 | C (23) | One or more of B (1) to B (18) | A (3) |
| 334 | C (23) | One or more of B (1) to B (18) | A (4) |
| 335 | C (23) | One or more of B (1) to B (18) | A (5) |
| 336 | C (23) | One or more of B (1) to B (18) | A (6) |
| 337 | C (23) | One or more of B (1) to B (18) | A (7) |
| 338 | C (23) | One or more of B (1) to B (18) | A (8) |
| 339 | C (23) | One or more of B (1) to B (18) | A (9) |
| 340 | C (23) | One or more of B (1) to B (18) | A (10) |
| 341 | C (23) | One or more of B (1) to B (18) | A (11) |
| 342 | C (23) | One or more of B (1) to B (18) | A (12) |
| 343 | C (23) | One or more of B (1) to B (18) | A (13) |
| 344 | C (23) | One or more of B (1) to B (18) | A (14) |
| 345 | C (23) | One or more of B (1) to B (18) | One or more of A (1) to A (14) |
| 346 | C (24) | One or more of B (1) to B (18) | A (1) |
| 347 | C (24) | One or more of B (1) to B (18) | A (2) |
| 348 | C (24) | One or more of B (1) to B (18) | A (3) |
| 349 | C (24) | One or more of B (1) to B (18) | A (4) |
| 350 | C (24) | One or more of B (1) to B (18) | A (5) |
| 351 | C (24) | One or more of B (1) to B (18) | A (6) |
| 352 | C (24) | One or more of B (1) to B (18) | A (7) |
| 353 | C (24) | One or more of B (1) to B (18) | A (8) |
| 354 | C (24) | One or more of B (1) to B (18) | A (9) |
| 355 | C (24) | One or more of B (1) to B (18) | A (10) |
| 356 | C (24) | One or more of B (1) to B (18) | A (11) |
| 357 | C (24) | One or more of B (1) to B (18) | A (12) |
| 358 | C (24) | One or more of B (1) to B (18) | A (13) |
| 359 | C (24) | One or more of B (1) to B (18) | A (14) |
| 360 | C (24) | One or more of B (1) to B (18) | One or more of A (1) to A (14) |
| 361 | C (25) | One or more of B (1) to B (18) | A (1) |
| 362 | C (25) | One or more of B (1) to B (18) | A (2) |
| 363 | C (25) | One or more of B (1) to B (18) | A (3) |
| 364 | C (25) | One or more of B (1) to B (18) | A (4) |
| 365 | C (25) | One or more of B (1) to B (18) | A (5) |
| 366 | C (25) | One or more of B (1) to B (18) | A (6) |
| 367 | C (25) | One or more of B (1) to B (18) | A (7) |
| 368 | C (25) | One or more of B (1) to B (18) | A (8) |
| 369 | C (25) | One or more of B (1) to B (18) | A (9) |
| 370 | C (25) | One or more of B (1) to B (18) | A (10) |
| 371 | C (25) | One or more of B (1) to B (18) | A (11) |
| 372 | C (25) | One or more of B (1) to B (18) | A (12) |
| 373 | C (25) | One or more of B (1) to B (18) | A (13) |
| 374 | C (25) | One or more of B (1) to B (18) | A (14) |
| 375 | C (25) | One or more of B (1) to B (18) | One or more of A (1) to A (14) |
| 376 | C (26) | One or more of B (1) to B (18) | A (1) |
| 377 | C (26) | One or more of B (1) to B (18) | A (2) |
| 378 | C (26) | One or more of B (1) to B (18) | A (3) |
| 379 | C (26) | One or more of B (1) to B (18) | A (4) |
| 380 | C (26) | One or more of B (1) to B (18) | A (5) |
| 381 | C (26) | One or more of B (1) to B (18) | A (6) |
| 382 | C (26) | One or more of B (1) to B (18) | A (7) |
| 383 | C (26) | One or more of B (1) to B (18) | A (8) |
| 384 | C (26) | One or more of B (1) to B (18) | A (9) |
| 385 | C (26) | One or more of B (1) to B (18) | A (10) |
| 386 | C (26) | One or more of B (1) to B (18) | A (11) |
| 387 | C (26) | One or more of B (1) to B (18) | A (12) |
| 388 | C (26) | One or more of B (1) to B (18) | A (13) |
| 389 | C (26) | One or more of B (1) to B (18) | A (14) |
| 390 | C (26) | One or more of B (1) to B (18) | One or more of A (1) to A (14) |
| 391 | C (27) | One or more of B (1) to B (18) | A (1) |
| 392 | C (27) | One or more of B (1) to B (18) | A (2) |
| 393 | C (27) | One or more of B (1) to B (18) | A (3) |
| 394 | C (27) | One or more of B (1) to B (18) | A (4) |
| 395 | C (27) | One or more of B (1) to B (18) | A (5) |
| 396 | C (27) | One or more of B (1) to B (18) | A (6) |
| 397 | C (27) | One or more of B (1) to B (18) | A (7) |
| 398 | C (27) | One or more of B (1) to B (18) | A (8) |
| 399 | C (27) | One or more of B (1) to B (18) | A (9) |
| 400 | C (27) | One or more of B (1) to B (18) | A (10) |
| 401 | C (27) | One or more of B (1) to B (18) | A (11) |
| 402 | C (27) | One or more of B (1) to B (18) | A (12) |
| 403 | C (27) | One or more of B (1) to B (18) | A (13) |
| 404 | C (27) | One or more of B (1) to B (18) | A (14) |
| 405 | C (27) | One or more of B (1) to B (18) | One or more of A (1) to A (14) |
| 406 | C (28) | One or more of B (1) to B (18) | A (1) |
| 407 | C (28) | One or more of B (1) to B (18) | A (2) |
| 408 | C (28) | One or more of B (1) to B (18) | A (3) |
| 409 | C (28) | One or more of B (1) to B (18) | A (4) |
| 410 | C (28) | One or more of B (1) to B (18) | A (5) |
| 411 | C (28) | One or more of B (1) to B (18) | A (6) |
| 412 | C (28) | One or more of B (1) to B (18) | A (7) |
| 413 | C (28) | One or more of B (1) to B (18) | A (8) |
| 414 | C (28) | One or more of B (1) to B (18) | A (9) |
| 415 | C (28) | One or more of B (1) to B (18) | A (10) |
| 416 | C (28) | One or more of B (1) to B (18) | A (11) |
| 417 | C (28) | One or more of B (1) to B (18) | A (12) |
| 418 | C (28) | One or more of B (1) to B (18) | A (13) |
| 419 | C (28) | One or more of B (1) to B (18) | A (14) |
| 420 | C (28) | One or more of B (1) to B (18) | One or more of A (1) to A (14) |
| 421 | C (29) | One or more of B (1) to B (18) | A (1) |
| 422 | C (29) | One or more of B (1) to B (18) | A (2) |
| 423 | C (29) | One or more of B (1) to B (18) | A (3) |
| 424 | C (29) | One or more of B (1) to B (18) | A (4) |
| 425 | C (29) | One or more of B (1) to B (18) | A (5) |
| 426 | C (29) | One or more of B (1) to B (18) | A (6) |
| 427 | C (29) | One or more of B (1) to B (18) | A (7) |
| 428 | C (29) | One or more of B (1) to B (18) | A (8) |
| 429 | C (29) | One or more of B (1) to B (18) | A (9) |
| 430 | C (29) | One or more of B (1) to B (18) | A (10) |
| 431 | C (29) | One or more of B (1) to B (18) | A (11) |
| 432 | C (29) | One or more of B (1) to B (18) | A (12) |
| 433 | C (29) | One or more of B (1) to B (18) | A (13) |
| 434 | C (29) | One or more of B (1) to B (18) | A (14) |
| 435 | C (29) | One or more of B (1) to B (18) | One or more of A (1) to A (14) |
| 436 | C (30) | One or more of B (1) to B (18) | A (1) |
| 437 | C (30) | One or more of B (1) to B (18) | A (2) |
| 438 | C (30) | One or more of B (1) to B (18) | A (3) |
| 439 | C (30) | One or more of B (1) to B (18) | A (4) |
| 440 | C (30) | One or more of B (1) to B (18) | A (5) |
| 441 | C (30) | One or more of B (1) to B (18) | A (6) |
| 442 | C (30) | One or more of B (1) to B (18) | A (7) |
| 443 | C (30) | One or more of B (1) to B (18) | A (8) |
| 444 | C (30) | One or more of B (1) to B (18) | A (9) |
| 445 | C (30) | One or more of B (1) to B (18) | A (10) |
| 446 | C (30) | One or more of B (1) to B (18) | A(11) |
| 447 | C (30) | One or more of B (1) to B (18) | A (12) |
| 448 | C (30) | One or more of B (1) to B (18) | A (13) |
| 449 | C (30) | One or more of B (1) to B (18) | A (14) |
| 450 | C (30) | One or more of B (1) to B (18) | One or more of A (1) to A (14) |
| 451 | C (31) | One or more of B (1) to B (18) | A (1) |
| 452 | C (31) | One or more of B (1) to B (18) | A (2) |
| 453 | C (31) | One or more of B (1) to B (18) | A (3) |
| 454 | C (31) | One or more of B (1) to B (18) | A (4) |
| 455 | C (31) | One or more of B (1) to B (18) | A (5) |
| 456 | C (31) | One or more of B (1) to B (18) | A (6) |
| 457 | C (31) | One or more of B (1) to B (18) | A (7) |
| 458 | C (31) | One or more of B (1) to B (18) | A (8) |
| 459 | C (31) | One or more of B (1) to B (18) | A (9) |
| 460 | C (31) | One or more of B (1) to B (18) | A (10) |
| 461 | C (31) | One or more of B (1) to B (18) | A (11) |
| 462 | C (31) | One or more of B (1) to B (18) | A (12) |
| 463 | C (31) | One or more of B (1) to B (18) | A (13) |
| 464 | C (31) | One or more of B (1) to B (18) | A (14) |
| 465 | C (31) | One or more of B (1) to B (18) | One or more of A (1) to A (14) |
| 466 | C (32) | One or more of B (1) to B (18) | A (1) |
| 467 | C (32) | One or more of B (1) to B (18) | A (2) |
| 468 | C (32) | One or more of B (1) to B (18) | A (3) |
| 469 | C (32) | One or more of B (1) to B (18) | A (4) |
| 470 | C (32) | One or more of B (1) to B (18) | A (5) |
| 471 | C (32) | One or more of B (1) to B (18) | A (6) |
| 472 | C (32) | One or more of B (1) to B (18) | A (7) |
| 473 | C (32) | One or more of B (1) to B (18) | A (8) |
| 474 | C (32) | One or more of B (1) to B (18) | A (9) |
| 475 | C (32) | One or more of B (1) to B (18) | A (10) |
| 476 | C (32) | One or more of B (1) to B (18) | A (11) |
| 477 | C (32) | One or more of B (1) to B (18) | A (12) |
| 478 | C (32) | One or more of B (1) to B (18) | A (13) |
| 479 | C (32) | One or more of B (1) to B (18) | A (14) |
| 480 | C (32) | One or more of B (1) to B (18) | One or more of A (1) to A (14) |
| 481 | C (33) | One or more of B (1) to B (18) | A (1) |
| 482 | C (33) | One or more of B (1) to B (18) | A (2) |
| 483 | C (33) | One or more of B (1) to B (18) | A (3) |
| 484 | C (33) | One or more of B (1) to B (18) | A (4) |
| 485 | C (33) | One or more of B (1) to B (18) | A (5) |
| 486 | C (33) | One or more of B (1) to B (18) | A (6) |
| 487 | C (33) | One or more of B (1) to B (18) | A (7) |
| 488 | C (33) | One or more of B (1) to B (18) | A (8) |
| 489 | C (33) | One or more of B (1) to B (18) | A (9) |
| 490 | C (33) | One or more of B (1) to B (18) | A (10) |
| 491 | C (33) | One or more of B (1) to B (18) | A (11) |
| 492 | C (33) | One or more of B (1) to B (18) | A (12) |
| 493 | C (33) | One or more of B (1) to B (18) | A (13) |
| 494 | C (33) | One or more of B (1) to B (18) | A (14) |
| 495 | C (33) | One or more of B (1) to B (18) | One or more of A (1) to A (14) |
| 496 | C (34) | One or more of B (1) to B (18) | A (1) |
| 497 | C (34) | One or more of B (1) to B (18) | A (2) |
| 498 | C (34) | One or more of B (1) to B (18) | A (3) |
| 499 | C (34) | One or more of B (1) to B (18) | A (4) |
| 500 | C (34) | One or more of B (1) to B (18) | A (5) |
| 501 | C (34) | One or more of B (1) to B (18) | A (6) |
| 502 | C (34) | One or more of B (1) to B (18) | A (7) |
| 503 | C (34) | One or more of B (1) to B (18) | A (8) |
| 504 | C (34) | One or more of B (1) to B (18) | A (9) |
| 505 | C (34) | One or more of B (1) to B (18) | A (10) |
| 506 | C (34) | One or more of B (1) to B (18) | A (11) |
| 507 | C (34) | One or more of B (1) to B (18) | A (12) |
| 508 | C (34) | One or more of B (1) to B (18) | A (13) |
| 509 | C (34) | One or more of B (1) to B (18) | A (14) |
| 510 | C (34) | One or more of B (1) to B (18) | One or more of A (1) to A (14) |
| 511 | C (35) | One or more of B (1) to B (18) | A (1) |
| 512 | C (35) | One or more of B (1) to B (18) | A (2) |
| 513 | C (35) | One or more of B (1) to B (18) | A (3) |
| 514 | C (35) | One or more of B (1) to B (18) | A (4) |
| 515 | C (35) | One or more of B (1) to B (18) | A (5) |
| 516 | C (35) | One or more of B (1) to B (18) | A (6) |
| 517 | C (35) | One or more of B (1) to B (18) | A (7) |
| 518 | C (35) | One or more of B (1) to B (18) | A (8) |
| 519 | C (35) | One or more of B (1) to B (18) | A (9) |
| 520 | C (35) | One or more of B (1) to B (18) | A (10) |
| 521 | C (35) | One or more of B (1) to B (18) | A (11) |
| 522 | C (35) | One or more of B (1) to B (18) | A (12) |
| 523 | C (35) | One or more of B (1) to B (18) | A (13) |
| 524 | C (35) | One or more of B (1) to B (18) | A (14) |
| 525 | C (35) | One or more of B (1) to B (18) | One or more of A (1) to A (14) |
| 526 | C (36) | One or more of B (1) to B (18) | A (1) |
| 527 | C (36) | One or more of B (1) to B (18) | A (2) |
| 528 | C (36) | One or more of B (1) to B (18) | A (3) |
| 529 | C (36) | One or more of B (1) to B (18) | A (4) |
| 530 | C (36) | One or more of B (1) to B (18) | A (5) |
| 531 | C (36) | One or more of B (1) to B (18) | A (6) |
| 532 | C (36) | One or more of B (1) to B (18) | A (7) |
| 533 | C (36) | One or more of B (1) to B (18) | A (8) |
| 534 | C (36) | One or more of B (1) to B (18) | A (9) |
| 535 | C (36) | One or more of B (1) to B (18) | A (10) |
| 536 | C (36) | One or more of B (1) to B (18) | A (11) |
| 537 | C (36) | One or more of B (1) to B (18) | A (12) |
| 538 | C (36) | One or more of B (1) to B (18) | A (13) |
| 539 | C (36) | One or more of B (1) to B (18) | A (14) |
| 540 | C (36) | One or more of B (1) to B (18) | One or more of A (1) to A (14) |
| 541 | C (37) | One or more of B (1) to B (18) | A (1) |
| 542 | C (37) | One or more of B (1) to B (18) | A (2) |
| 543 | C (37) | One or more of B (1) to B (18) | A (3) |
| 544 | C (37) | One or more of B (1) to B (18) | A (4) |
| 545 | C (37) | One or more of B (1) to B (18) | A (5) |
| 546 | C (37) | One or more of B (1) to B (18) | A (6) |
| 547 | C (37) | One or more of B (1) to B (18) | A (7) |
| 548 | C (37) | One or more of B (1) to B (18) | A (8) |
| 549 | C (37) | One or more of B (1) to B (18) | A (9) |
| 550 | C (37) | One or more of B (1) to B (18) | A (10) |
| 551 | C (37) | One or more of B (1) to B (18) | A (11) |
| 552 | C (37) | One or more of B (1) to B (18) | A (12) |
| 553 | C (37) | One or more of B (1) to B (18) | A (13) |
| 554 | C (37) | One or more of B (1) to B (18) | A (14) |
| 555 | C (37) | One or more of B (1) to B (18) | One or more of A (1) to A (14) |
| 556 | C (38) | One or more of B (1) to B (18) | A (1) |
| 557 | C (38) | One or more of B (1) to B (18) | A (2) |
| 558 | C (38) | One or more of B (1) to B (18) | A (3) |
| 559 | C (38) | One or more of B (1) to B (18) | A (4) |
| 560 | C (38) | One or more of B (1) to B (18) | A (5) |
| 561 | C (38) | One or more of B (1) to B (18) | A (6) |
| 562 | C (38) | One or more of B (1) to B (18) | A (7) |
| 563 | C (38) | One or more of B (1) to B (18) | A (8) |
| 564 | C (38) | One or more of B (1) to B (18) | A (9) |
| 565 | C (38) | One or more of B (1) to B (18) | A (10) |
| 566 | C (38) | One or more of B (1) to B (18) | A (11) |
| 567 | C (38) | One or more of B (1) to B (18) | A (12) |
| 568 | C (38) | One or more of B (1) to B (18) | A (13) |
| 569 | C (38) | One or more of B (1) to B (18) | A (14) |
| 570 | C (38) | One or more of B (1) to B (18) | One or more of A (1) to A (14) |
| 571 | C (39) | One or more of B (1) to B (18) | A (1) |
| 572 | C (39) | One or more of B (1) to B (18) | A (2) |
| 573 | C (39) | One or more of B (1) to B (18) | A (3) |
| 574 | C (39) | One or more of B (1) to B (18) | A (4) |
| 575 | C (39) | One or more of B (1) to B (18) | A (5) |
| 576 | C (39) | One or more of B (1) to B (18) | A (6) |
| 577 | C (39) | One or more of B (1) to B (18) | A (7) |
| 578 | C (39) | One or more of B (1) to B (18) | A (8) |
| 579 | C (39) | One or more of B (1) to B (18) | A (9) |
| 580 | C (39) | One or more of B (1) to B (18) | A (10) |
| 581 | C (39) | One or more of B (1) to B (18) | A (11) |
| 582 | C (39) | One or more of B (1) to B (18) | A (12) |
| 583 | C (39) | One or more of B (1) to B (18) | A (13) |
| 584 | C (39) | One or more of B (1) to B (18) | A (14) |
| 585 | C (39) | One or more of B (1) to B (18) | One or more of A (1) to A (14) |
| 586 | C (40) | One or more of B (1) to B (18) | A (1) |
| 587 | C (40) | One or more of B (1) to B (18) | A (2) |
| 588 | C (40) | One or more of B (1) to B (18) | A (3) |
| 589 | C (40) | One or more of B (1) to B (18) | A (4) |
| 590 | C (40) | One or more of B (1) to B (18) | A (5) |
| 591 | C (40) | One or more of B (1) to B (18) | A (6) |
| 592 | C (40) | One or more of B (1) to B (18) | A (7) |
| 593 | C (40) | One or more of B (1) to B (18) | A (8) |
| 594 | C (40) | One or more of B (1) to B (18) | A (9) |
| 595 | C (40) | One or more of B (1) to B (18) | A (10) |
| 596 | C (40) | One or more of B (1) to B (18) | A (11) |
| 597 | C (40) | One or more of B (1) to B (18) | A (12) |
| 598 | C (40) | One or more of B (1) to B (18) | A (13) |
| 599 | C (40) | One or more of B (1) to B (18) | A (14) |
| 600 | C (40) | One or more of B (1) to B (18) | One or more of A (1) to A (14) |
| 601 | C (41) | One or more of B (1) to B (18) | A (1) |
| 602 | C (41) | One or more of B (1) to B (18) | A (2) |
| 603 | C (41) | One or more of B (1) to B (18) | A (3) |
| 604 | C (41) | One or more of B (1) to B (18) | A (4) |
| 605 | C (41) | One or more of B (1) to B (18) | A (5) |
| 606 | C (41) | One or more of B (1) to B (18) | A (6) |
| 607 | C (41) | One or more of B (1) to B (18) | A (7) |
| 608 | C (41) | One or more of B (1) to B (18) | A (8) |
| 609 | C (41) | One or more of B (1) to B (18) | A (9) |
| 610 | C (41) | One or more of B (1) to B (18) | A (10) |
| 611 | C (41) | One or more of B (1) to B (18) | A (11) |
| 612 | C (41) | One or more of B (1) to B (18) | A (12) |
| 613 | C (41) | One or more of B (1) to B (18) | A (13) |
| 614 | C (41) | One or more of B (1) to B (18) | A (14) |
| 615 | C (41) | One or more of B (1) to B (18) | One or more of A (1) to A (14) |
| 616 | C (42) | One or more of B (1) to B (18) | A (1) |
| 617 | C (42) | One or more of B (1) to B (18) | A (2) |
| 618 | C (42) | One or more of B (1) to B (18) | A (3) |
| 619 | C (42) | One or more of B (1) to B (18) | A (4) |
| 620 | C (42) | One or more of B (1) to B (18) | A (5) |
| 621 | C (42) | One or more of B (1) to B (18) | A (6) |
| 622 | C (42) | One or more of B (1) to B (18) | A (7) |
| 623 | C (42) | One or more of B (1) to B (18) | A (8) |
| 624 | C (42) | One or more of B (1) to B (18) | A (9) |
| 625 | C (42) | One or more of B (1) to B (18) | A (10) |
| 626 | C (43) | One or more of B (1) to B (18) | A (11) |
| 627 | C (43) | One or more of B (1) to B (18) | A (12) |
| 628 | C (43) | One or more of B (1) to B (18) | A (13) |
| 629 | C (43) | One or more of B (1) to B (18) | A (14) |
| 630 | C (43) | One or more of B (1) to B (18) | One or more of A (1) to A (14) |
| 631 | C (43) | One or more of B (1) to B (18) | A (1) |
| 632 | C (43) | One or more of B (1) to B (18) | A (2) |
| 633 | C (43) | One or more of B (1) to B (18) | A (3) |
| 634 | C (43) | One or more of B (1) to B (18) | A (4) |
| 635 | C (43) | One or more of B (1) to B (18) | A (5) |
| 636 | C (43) | One or more of B (1) to B (18) | A (6) |
| 637 | C (43) | One or more of B (1) to B (18) | A (7) |
| 638 | C (43) | One or more of B (1) to B (18) | A (8) |
| 639 | C (43) | One or more of B (1) to B (18) | A (9) |
| 640 | C (43) | One or more of B (1) to B (18) | A (10) |
| 641 | C (43) | One or more of B (1) to B (18) | A (11) |
| 642 | C (43) | One or more of B (1) to B (18) | A (12) |
| 643 | C (43) | One or more of B (1) to B (18) | A (13) |
| 644 | C (43) | One or more of B (1) to B (18) | A (14) |
| 645 | C (43) | One or more of B (1) to B (18) | One or more of A (1) to A (14) |
| 646 | C (44) | One or more of B (1) to B (18) | A (1) |
| 647 | C (44) | One or more of B (1) to B (18) | A (2) |
| 648 | C (44) | One or more of B (1) to B (18) | A (3) |
| 649 | C (44) | One or more of B (1) to B (18) | A (4) |
| 650 | C (44) | One or more of B (1) to B (18) | A (5) |
| 651 | C (44) | One or more of B (1) to B (18) | A (6) |
| 652 | C (44) | One or more of B (1) to B (18) | A (7) |
| 653 | C (44) | One or more of B (1) to B (18) | A (8) |
| 654 | C (44) | One or more of B (1) to B (18) | A (9) |
| 655 | C (44) | One or more of B (1) to B (18) | A (10) |
| 656 | C (44) | One or more of B (1) to B (18) | A (11) |
| 657 | C (44) | One or more of B (1) to B (18) | A (12) |
| 658 | C (44) | One or more of B (1) to B (18) | A (13) |
| 659 | C (44) | One or more of B (1) to B (18) | A (14) |
| 660 | C (44) | One or more of B (1) to B (18) | One or more of A (1) to A (14) |
| 661 | C (45) | One or more of B (1) to B (18) | A (1) |
| 662 | C (45) | One or more of B (1) to B (18) | A (2) |
| 663 | C (45) | One or more of B (1) to B (18) | A (3) |
| 664 | C (45) | One or more of B (1) to B (18) | A (4) |
| 665 | C (45) | One or more of B (1) to B (18) | A (5) |
| 666 | C (45) | One or more of B (1) to B (18) | A (6) |
| 667 | C (45) | One or more of B (1) to B (18) | A (7) |
| 668 | C (45) | One or more of B (1) to B (18) | A (8) |
| 669 | C (45) | One or more of B (1) to B (18) | A (9) |
| 670 | C (45) | One or more of B (1) to B (18) | A (10) |
| 671 | C (45) | One or more of B (1) to B (18) | A (11) |
| 672 | C (45) | One or more of B (1) to B (18) | A (12) |
| 673 | C (45) | One or more of B (1) to B (18) | A (13) |
| 674 | C (45) | One or more of B (1) to B (18) | A (14) |
| 675 | C (45) | One or more of B (1) to B (18) | One or more of A (1) to A (14) |
| 676 | C (46) | One or more of B (1) to B (18) | A (1) |
| 677 | C (46) | One or more of B (1) to B (18) | A (2) |
| 678 | C (46) | One or more of B (1) to B (18) | A (3) |
| 679 | C (46) | One or more of B (1) to B (18) | A (4) |
| 680 | C (46) | One or more of B (1) to B (18) | A (5) |
| 681 | C (46) | One or more of B (1) to B (18) | A (6) |
| 682 | C (46) | One or more of B (1) to B (18) | A (7) |
| 683 | C (46) | One or more of B (1) to B (18) | A (8) |
| 684 | C (46) | One or more of B (1) to B (18) | A (9) |
| 685 | C (46) | One or more of B (1) to B (18) | A (10) |
| 686 | C (46) | One or more of B (1) to B (18) | A (11) |
| 687 | C (46) | One or more of B (1) to B (18) | A (12) |
| 688 | C (46) | One or more of B (1) to B (18) | A (13) |
| 689 | C (46) | One or more of B (1) to B (18) | A (14) |
| 690 | C (46) | One or more of B (1) to B (18) | One or more of A (1) to A (14) |
| 691 | C (47) | One or more of B (1) to B (18) | A (1) |
| 692 | C (47) | One or more of B (1) to B (18) | A (2) |
| 693 | C (47) | One or more of B (1) to B (18) | A (3) |
| 694 | C (47) | One or more of B (1) to B (18) | A (4) |
| 695 | C (47) | One or more of B (1) to B (18) | A (5) |
| 696 | C (47) | One or more of B (1) to B (18) | A (6) |
| 697 | C (47) | One or more of B (1) to B (18) | A (7) |
| 698 | C (47) | One or more of B (1) to B (18) | A (8) |
| 699 | C (47) | One or more of B (1) to B (18) | A (9) |
| 700 | C (47) | One or more of B (1) to B (18) | A (10) |
| 701 | C (47) | One or more of B (1) to B (18) | A (11) |
| 702 | C (47) | One or more of B (1) to B (18) | A (12) |
| 703 | C (47) | One or more of B (1) to B (18) | A (13) |
| 704 | C (47) | One or more of B (1) to B (18) | A (14) |
| 705 | C (47) | One or more of B (1) to B (18) | One or more of A (1) to A (14) |
| 706 | C (48) | One or more of B (1) to B (18) | A (1) |
| 707 | C (48) | One or more of B (1) to B (18) | A (2) |
| 708 | C (48) | One or more of B (1) to B (18) | A (3) |
| 709 | C (48) | One or more of B (1) to B (18) | A (4) |
| 710 | C (48) | One or more of B (1) to B (18) | A (5) |
| 711 | C (48) | One or more of B (1) to B (18) | A (6) |
| 712 | C (48) | One or more of B (1) to B (18) | A (7) |
| 713 | C (48) | One or more of B (1) to B (18) | A (8) |
| 714 | C (48) | One or more of B (1) to B (18) | A (9) |
| 715 | C (48) | One or more of B (1) to B (18) | A (10) |
| 716 | C (48) | One or more of B (1) to B (18) | A (11) |
| 717 | C (48) | One or more of B (1) to B (18) | A (12) |
| 718 | C (48) | One or more of B (1) to B (18) | A (13) |
| 719 | C (48) | One or more of B (1) to B (18) | A (14) |
| 720 | C (48) | One or more of B (1) to B (18) | One or more of A (1) to A (14) |
| 721 | C (49) | One or more of B (1) to B (18) | A (1) |
| 722 | C (49) | One or more of B (1) to B (18) | A (2) |
| 723 | C (49) | One or more of B (1) to B (18) | A (3) |
| 724 | C (49) | One or more of B (1) to B (18) | A (4) |
| 725 | C (49) | One or more of B (1) to B (18) | A (5) |
| 726 | C (49) | One or more of B (1) to B (18) | A (6) |
| 727 | C (49) | One or more of B (1) to B (18) | A (7) |
| 728 | C (49) | One or more of B (1) to B (18) | A (8) |
| 729 | C (49) | One or more of B (1) to B (18) | A (9) |
| 730 | C (49) | One or more of B (1) to B (18) | A (10) |
| 731 | C (49) | One or more of B (1) to B (18) | A (11) |
| 732 | C (49) | One or more of B (1) to B (18) | A (12) |
| 733 | C (49) | One or more of B (1) to B (18) | A (13) |
| 734 | C (49) | One or more of B (1) to B (18) | A (14) |
| 735 | C (49) | One or more of B (1) to B (18) | One or more of A (1) to A (14) |
| 736 | C (50) | One or more of B (1) to B (18) | A (1) |
| 737 | C (50) | One or more of B (1) to B (18) | A (2) |
| 738 | C (50) | One or more of B (1) to B (18) | A (3) |
| 739 | C (50) | One or more of B (1) to B (18) | A (4) |
| 740 | C (50) | One or more of B (1) to B (18) | A (5) |
| 741 | C (50) | One or more of B (1) to B (18) | A (6) |
| 742 | C (50) | One or more of B (1) to B (18) | A (7) |
| 743 | C (50) | One or more of B (1) to B (18) | A (8) |
| 744 | C (50) | One or more of B (1) to B (18) | A (9) |
| 745 | C (50) | One or more of B (1) to B (18) | A (10) |
| 746 | C (50) | One or more of B (1) to B (18) | A (11) |
| 747 | C (50) | One or more of B (1) to B (18) | A (12) |
| 748 | C (50) | One or more of B (1) to B (18) | A (13) |
| 749 | C (50) | One or more of B (1) to B (18) | A (14) |
| 750 | C (50) | One or more of B (1) to B (18) | One or more of A (1) to A (14) |
| 751 | C (51) | One or more of B (1) to B (18) | A (1) |
| 752 | C (51) | One or more of B (1) to B (18) | A (2) |
| 753 | C (51) | One or more of B (1) to B (18) | A (3) |
| 754 | C (51) | One or more of B (1) to B (18) | A (4) |
| 755 | C (51) | One or more of B (1) to B (18) | A (5) |
| 756 | C (51) | One or more of B (1) to B (18) | A (6) |
| 757 | C (51) | One or more of B (1) to B (18) | A (7) |
| 758 | C (51) | One or more of B (1) to B (18) | A (8) |
| 759 | C (51) | One or more of B (1) to B (18) | A (9) |
| 760 | C (51) | One or more of B (1) to B (18) | A (10) |
| 761 | C (51) | One or more of B (1) to B (18) | A (11) |
| 762 | C (51) | One or more of B (1) to B (18) | A (12) |
| 763 | C (51) | One or more of B (1) to B (18) | A (13) |
| 764 | C (51) | One or more of B (1) to B (18) | A (14) |
| 765 | C (51) | One or more of B (1) to B (18) | One or more of A (1) to A (14) |
| 766 | C (52) | One or more of B (1) to B (18) | A (1) |
| 767 | C (52) | One or more of B (1) to B (18) | A (2) |
| 768 | C (52) | One or more of B (1) to B (18) | A (3) |
| 769 | C (52) | One or more of B (1) to B (18) | A (4) |
| 770 | C (52) | One or more of B (1) to B (18) | A (5) |
| 771 | C (52) | One or more of B (1) to B (18) | A (6) |
| 772 | C (52) | One or more of B (1) to B (18) | A (7) |
| 773 | C (52) | One or more of B (1) to B (18) | A (8) |
| 774 | C (52) | One or more of B (1) to B (18) | A (9) |
| 775 | C (52) | One or more of B (1) to B (18) | A (10) |
| 776 | C (52) | One or more of B (1) to B (18) | A (11) |
| 777 | C (52) | One or more of B (1) to B (18) | A (12) |
| 778 | C (52) | One or more of B (1) to B (18) | A (13) |
| 779 | C (52) | One or more of B (1) to B (18) | A (14) |
| 780 | C (52) | One or more of B (1) to B (18) | One or more of A (1) to A (14) |
| 781 | C (53) | One or more of B (1) to B (18) | A (1) |
| 782 | C (53) | One or more of B (1) to B (18) | A (2) |
| 783 | C (53) | One or more of B (1) to B (18) | A (3) |
| 784 | C (53) | One or more of B (1) to B (18) | A (4) |
| 785 | C (53) | One or more of B (1) to B (18) | A (5) |
| 786 | C (53) | One or more of B (1) to B (18) | A (6) |
| 787 | C (53) | One or more of B (1) to B (18) | A (7) |
| 788 | C (53) | One or more of B (1) to B (18) | A (8) |
| 789 | C (53) | One or more of B (1) to B (18) | A (9) |
| 790 | C (53) | One or more of B (1) to B (18) | A (10) |
| 791 | C (53) | One or more of B (1) to B (18) | A (11) |
| 792 | C (53) | One or more of B (1) to B (18) | A (12) |
| 793 | C (53) | One or more of B (1) to B (18) | A (13) |
| 794 | C (53) | One or more of B (1) to B (18) | A (14) |
| 795 | C (53) | One or more of B (1) to B (18) | One or more of A (1) to A (14) |
| 796 | C (54) | One or more of B (1) to B (18) | A (1) |
| 797 | C (54) | One or more of B (1) to B (18) | A (2) |
| 798 | C (54) | One or more of B (1) to B (18) | A (3) |
| 799 | C (54) | One or more of B (1) to B (18) | A (4) |
| 800 | C (54) | One or more of B (1) to B (18) | A (5) |
| 801 | C (54) | One or more of B (1) to B (18) | A (6) |
| 802 | C (54) | One or more of B (1) to B (18) | A (7) |
| 803 | C (54) | One or more of B (1) to B (18) | A (8) |
| 804 | C (54) | One or more of B (1) to B (18) | A (9) |
| 805 | C (54) | One or more of B (1) to B (18) | A (10) |
| 806 | C (54) | One or more of B (1) to B (18) | A (11) |
| 807 | C (54) | One or more of B (1) to B (18) | A (12) |
| 808 | C (54) | One or more of B (1) to B (18) | A (13) |
| 809 | C (54) | One or more of B (1) to B (18) | A (14) |
| 810 | C (54) | One or more of B (1) to B (18) | One or more of A (1) to A (14) |
| 811 | C (55) | One or more of B (1) to B (18) | A (1) |
| 812 | C (55) | One or more of B (1) to B (18) | A (2) |
| 813 | C (55) | One or more of B (1) to B (18) | A (3) |
| 814 | C (55) | One or more of B (1) to B (18) | A (4) |
| 815 | C (55) | One or more of B (1) to B (18) | A (5) |
| 816 | C (55) | One or more of B (1) to B (18) | A (6) |
| 817 | C (55) | One or more of B (1) to B (18) | A (7) |
| 818 | C (55) | One or more of B (1) to B (18) | A (8) |
| 819 | C (55) | One or more of B (1) to B (18) | A (9) |
| 820 | C (55) | One or more of B (1) to B (18) | A (10) |
| 821 | C (55) | One or more of B (1) to B (18) | A (11) |
| 822 | C (55) | One or more of B (1) to B (18) | A (12) |
| 823 | C (55) | One or more of B (1) to B (18) | A (13) |
| 824 | C (55) | One or more of B (1) to B (18) | A (14) |
| 825 | C (55) | One or more of B (1) to B (18) | One or more of A (1) to A (14) |
| 826 | C (56) | One or more of B (1) to B (18) | A (1) |
| 827 | C (56) | One or more of B (1) to B (18) | A (2) |
| 828 | C (56) | One or more of B (1) to B (18) | A (3) |
| 829 | C (56) | One or more of B (1) to B (18) | A (4) |
| 830 | C (56) | One or more of B (1) to B (18) | A (5) |
| 831 | C (56) | One or more of B (1) to B (18) | A (6) |
| 832 | C (56) | One or more of B (1) to B (18) | A (7) |
| 833 | C (56) | One or more of B (1) to B (18) | A (8) |
| 834 | C (56) | One or more of B (1) to B (18) | A (9) |
| 835 | C (56) | One or more of B (1) to B (18) | A (10) |
| 836 | C (56) | One or more of B (1) to B (18) | A (11) |
| 837 | C (56) | One or more of B (1) to B (18) | A (12) |
| 838 | C (56) | One or more of B (1) to B (18) | A (13) |
| 839 | C (56) | One or more of B (1) to B (18) | A (14) |
| 840 | C (56) | One or more of B (1) to B (18) | One or more of A (1) to A (14) |
| 841 | C (57) | One or more of B (1) to B (18) | A (1) |
| 842 | C (57) | One or more of B (1) to B (18) | A (2) |
| 843 | C (57) | One or more of B (1) to B (18) | A (3) |
| 844 | C (57) | One or more of B (1) to B (18) | A (4) |
| 845 | C (57) | One or more of B (1) to B (18) | A (5) |
| 846 | C (57) | One or more of B (1) to B (18) | A (6) |
| 847 | C (57) | One or more of B (1) to B (18) | A (7) |
| 848 | C (57) | One or more of B (1) to B (18) | A (8) |
| 849 | C (57) | One or more of B (1) to B (18) | A (9) |
| 850 | C (57) | One or more of B (1) to B (18) | A (10) |
| 851 | C (57) | One or more of B (1) to B (18) | A (11) |
| 852 | C (57) | One or more of B (1) to B (18) | A (12) |
| 853 | C (57) | One or more of B (1) to B (18) | A (13) |
| 854 | C (57) | One or more of B (1) to B (18) | A (14) |
| 855 | C (57) | One or more of B (1) to B (18) | One or more of A (1) to A (14) |
| 856 | C (58) | One or more of B (1) to B (18) | A (1) |
| 857 | C (58) | One or more of B (1) to B (18) | A (2) |
| 858 | C (58) | One or more of B (1) to B (18) | A (3) |
| 859 | C (58) | One or more of B (1) to B (18) | A (4) |
| 860 | C (58) | One or more of B (1) to B (18) | A (5) |
| 861 | C (58) | One or more of B (1) to B (18) | A (6) |
| 862 | C (58) | One or more of B (1) to B (18) | A (7) |
| 863 | C (58) | One or more of B (1) to B (18) | A (8) |
| 864 | C (58) | One or more of B (1) to B (18) | A (9) |
| 865 | C (58) | One or more of B (1) to B (18) | A (10) |
| 866 | C (58) | One or more of B (1) to B (18) | A (11) |
| 867 | C (58) | One or more of B (1) to B (18) | A (12) |
| 868 | C (58) | One or more of B (1) to B (18) | A (13) |
| 869 | C (58) | One or more of B (1) to B (18) | A (14) |
| 870 | C (58) | One or more of B (1) to B (18) | One or more of A (1) to A (14) |

In yet another embodiment, all the combinations in Table 4 may be considered as separate embodiments of the present disclosure.

In an embodiment, the present disclosure provides a herbicidal combination comprising:
(a) at least one HPPD inhibitor herbicide comprising A (1) to A (14) or a combination thereof;
(b) at least one microtubule assembly inhibitor herbicide comprising B (1) to B (18) or a combination thereof; and
(c) at least one AHAS inhibitor herbicide comprising C (1) to C (58) or a combination thereof.

In an embodiment, the present disclosure provides a herbicidal combination comprising:
(a) at least one HPPD inhibitor herbicide;
(b) at least one microtubule assembly inhibitor herbicide; and
(c) at least one AHAS inhibitor herbicide;
wherein the HPPD inhibitor herbicide is mesotrione.

In an embodiment, the present disclosure provides a herbicidal combination comprising:
(a) at least one HPPD inhibitor herbicide;
(b) at least one microtubule assembly inhibitor herbicide; and
(c) at least one AHAS inhibitor herbicide;
wherein the microtubule assembly inhibitor herbicide is pendimethalin.

In an embodiment, the present disclosure provides a herbicidal combination comprising:
(a) at least one HPPD inhibitor herbicide;
(b) at least one microtubule assembly inhibitor herbicide; and
(c) at least one AHAS inhibitor herbicide;
wherein the AHAS inhibitor herbicide is imazamox.

In an embodiment, the present disclosure provides a herbicidal combination comprising:
(a) at least one HPPD inhibitor herbicide;
(b) at least one microtubule assembly inhibitor herbicide; and
(c) at least one AHAS inhibitor herbicide;
wherein the AHAS inhibitor herbicide is rimsulfuron.

In an embodiment, the present disclosure provides a herbicidal combination comprising:
(a) at least one HPPD inhibitor herbicide;
(b) at least one microtubule assembly inhibitor herbicide; and
(c) at least one AHAS inhibitor herbicide;
wherein the HPPD inhibitor herbicide is mesotrione; wherein the microtubule assembly inhibitor herbicide is pendimethalin; and wherein the AHAS inhibitor herbicide is imazamox.

In an embodiment, the present disclosure provides a herbicidal combination comprising:
(a) at least one HPPD inhibitor herbicide;
(b) at least one microtubule assembly inhibitor herbicide; and
(c) at least one AHAS inhibitor herbicide;
wherein the HPPD inhibitor herbicide is mesotrione; wherein the microtubule assembly inhibitor herbicide is pendimethalin; and wherein the AHAS inhibitor herbicide is rimsulfuron.

In one embodiment, the present disclosure provides a herbicidal combination comprising:
(a) mesotrione;
(b) pendimethalin; and
(c) imazamox.

In one embodiment, the present disclosure provides a herbicidal combination comprising:
(a) mesotrione;
(b) pendimethalin; and
(c) rimsulfuron.

In another embodiment, the present disclosure provides a herbicidal combination comprising mesotrione, pendimethalin and imazamox, wherein a weight ratio of mesotrione to pendimethalin to imazamox ranges from about 1:0.1:0.1 to about 1:100:100.

In one embodiment, the weight ratio of mesotrione to pendimethalin to imazamox is selected from ratios comprising 1:0.1:0.1, 1:1:1, 1:10:10, 1:20:20, 1:30:30, 1:40:40, 1:50:50, 1:60:60, 1:70:70, 1:80:80, 1:90:90, 1:100:100.

In another embodiment, the present disclosure provides a herbicidal combination comprising mesotrione, pendimethalin and rimsulfuron, wherein weight ratio of mesotrione to pendimethalin to rimsulfuron ranges from about 1:0.1:0.1 to about 1:100:100.

In one embodiment, the weight ratio of mesotrione to pendimethalin to rimsulfuron is selected from ratios comprising 1:0.1:0.1, 1:1:1, 1:10:10, 1:20:20, 1:30:30, 1:40:40, 1:50:50, 1:60:60, 1:70:70, 1:80:80, 1:90:90, 1:100:100.

Accordingly in an embodiment, the present disclosure provides an agrochemical composition.

Accordingly in an embodiment, the present disclosure provides a herbicidal composition.

In an embodiment, the present disclosure provides a herbicidal composition comprising:
(a) at least one HPPD inhibitor herbicide;
(b) at least one microtubule assembly inhibitor herbicide; and
(c) at least one AHAS inhibitor herbicide.

In an embodiment, the present disclosure provides a herbicidal composition comprising:
(a) at least one HPPD inhibitor herbicide comprising A (1) to A (14) or a combination thereof;
(b) at least one microtubule assembly inhibitor herbicide comprising B (1) to B (18) or a combination thereof; and
(c) at least one AHAS inhibitor herbicide comprising C (1) to C (58) or a combination thereof.

In one embodiment, the present disclosure provides a herbicidal composition comprising:
(a) mesotrione;
(b) pendimethalin; and
(c) imazamox.

In one embodiment, the present disclosure provides a herbicidal composition comprising:
(a) mesotrione;
(b) pendimethalin; and
(c) rimsulfuron.

In an embodiment, the present disclosure provides a herbicidal composition comprising:
(a) at least one HPPD inhibitor herbicide;
(b) at least one microtubule assembly inhibitor herbicide;
(c) at least one AHAS inhibitor herbicide; and
(d) at least one agrochemically acceptable excipient.

In an embodiment, the present disclosure provides a herbicidal composition comprising:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof; and
(d) at least one agrochemically acceptable excipient.

In another embodiment, the present disclosure provides an agrochemical combination comprising any of the 870 combinations identified in Table 4.

In another embodiment, the present disclosure provides a herbicidal composition comprising any of the 870 combinations identified in Table 4.

In a preferred embodiment, the present disclosure provides a herbicidal composition comprising:
(a) mesotrione;
(b) pendimethalin;
(c) imazamox; and
(d) at least one agrochemically acceptable excipient.

In one embodiment, the present disclosure provides a herbicidal composition comprising:
(a) mesotrione;
(b) pendimethalin;
(c) rimsulfuron; and
(d) at least one agrochemically acceptable excipient.

According to an embodiment of the present disclosure, the agrochemically acceptable excipients are selected from one or more of emulsifiers, colorants, thickeners/binders, antifreeze agents, antifoaming agents, antioxidants, solvents, preservatives, glidants, anticaking agents, pH-regulating agents, buffering agents, formulation aids, disintegrants, or combinations thereof.

In another embodiment, emulsifiers, which can be advantageously employed herein, can be readily determined by those skilled in the art and include various non-ionic, anionic, cationic, and amphoteric emulsifiers, or a blend of two or more emulsifiers. Examples of non-ionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether.

In an embodiment, colorants may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

In an embodiment, a thickener or gelling agent may be selected from, but not limited to, molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylamide polymers and copolymers, polyhydroxyethyl acrylate, methylacrylamide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols.

In another embodiment, antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethyl ether, diethylene glycol monoethyl ether, triethylene glycol monomethyl ether, butoxyethanol, butylene glycol monobutyl ether, dipentaerythritol, tripentaerythritol, tetrapentaerythritol, diglycerol, triglycerol, tetraglycerol, pentaglycerol, hexaglycerol, heptaglycerol, octaglycerol.

According to an embodiment, the antifoam agent may be selected from polydimethoxysiloxane, polydimethylsiloxane, alkyl poly acrylates, castor oil, fatty acids, fatty acid esters, fatty acid sulfates, fatty alcohol, fatty alcohol esters, fatty alcohol sulfate, foot olive oil, mono & di glyceride, paraffin oil, paraffin wax, poly propylene glycol, silicones oil, vegetable fats, vegetable fats sulfate, vegetable oil, vegetable oil sulfate, vegetable wax, vegetable wax sulfate, agents based on silicon or magnesium stearate.

In another embodiment, antioxidants are, for example, amino acids (e.g., glycine, histidine, tyrosine, tryptophan) and derivatives thereof, imidazole and imidazole derivatives (e.g., urocanic acid), peptides, such as, for example, D,L-camosine, D-carnosine, L-carnosine and derivatives thereof (e.g., anserine), carotenoids, carotenes (e.g., α-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g., buthionine sulfoximines, homocysteine sulfoximine, buthionine sulfones, penta-, hexa-, heptathionine sulfoximine) in very low tolerated doses, also metal chelating agents (e.g., α-hydroxy fatty acids, EDTA, EGTA, phytic acid, lactoferrin), α-hydroxy acids (e.g., citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., γ-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, magnesium ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g., stilbene oxide, trans-stilbene oxide). According to the disclosure, suitable derivatives (salts, esters, sugars, nucleotides, nucleosides, peptides, and lipids) and mixtures of these specified active ingredients or plant extracts (e.g., tea tree oil, rosemary extract and rosemarinic acid) which comprise these antioxidants can be used. In general, mixtures of the aforementioned antioxidants are possible.

According to an embodiment, examples of suitable solvents are water, oils of vegetable, or derivatives. In principle, solvent mixtures may also be used.

In another embodiment, suitable preservatives are for example benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl and benzoic acid & combination thereof.

According to an embodiment, the herbicidal composition comprises from about 0.1% w/w to about 70% w/w of mesotrione of total weight of the composition.

In one embodiment, the herbicidal composition comprises from about 1% w/w to about 60% w/w of mesotrione of total weight of the composition.

In one embodiment, the herbicidal composition comprises from about 10% w/w to about 50% w/w of mesotrione of total weight of the composition.

According to an embodiment, the herbicidal composition comprises from about 0.1% w/w to about 70% w/w of pendimethalin of total weight of the composition.

In one embodiment, the herbicidal composition comprises from about 1% w/w to about 70% w/w of pendimethalin of total weight of the composition.

In one embodiment, the herbicidal composition comprises from about 10% w/w to about 50% w/w of pendimethalin of total weight of the composition.

According to an embodiment, the herbicidal composition comprises from about 0.1% w/w to about 70% w/w of imazamox of total weight of the composition.

In one embodiment, the herbicidal composition comprises from about 1% w/w to about 60% w/w of imazamox of total weight of the composition.

In one embodiment, the herbicidal composition comprises from about 10% w/w to about 50% w/w of imazamox of total weight of the composition.

According to an embodiment, the herbicidal composition comprises from about 0.1% w/w to about 70% w/w of rimsulfuron of total weight of the composition.

In one embodiment, the herbicidal composition comprises from about 1% w/w to about 60% w/w of rimsulfuron of total weight of the composition.

In one embodiment, the herbicidal composition comprises from about 10% w/w to about 50% w/w of rimsulfuron of total weight of the composition.

According to an embodiment, the herbicidal composition comprises from about 1% w/w to about 30% w/w of agrochemically acceptable excipient of total weight of the composition.

According to an embodiment, the present disclosure provides a herbicidal composition comprising:
(a) from about 0.1% w/w to about 70% w/w mesotrione;
(b) from about 0.1% w/w to about 70% w/w pendimethalin;
(c) from about 0.1% w/w to about 70% w/w imazamox; and
(d) from about 1% w/w to about 30% w/w at least one agrochemically acceptable excipient.

According to an embodiment, the present disclosure provides a herbicidal composition comprising:
(a) from about 0.1% w/w to about 70% w/w mesotrione;
(b) from about 0.1% w/w to about 70% w/w pendimethalin;
(c) from about 0.1% w/w to about 70% w/w rimsulfuron; and
(d) from about 1% w/w to about 30% w/w at least one agrochemically acceptable excipient.

In one embodiment, the present disclosure provides a herbicidal composition comprising:
(a) from about 1% w/w to about 60% w/w mesotrione;
(b) from about 1% w/w to about 60% w/w pendimethalin;
(c) from about 1% w/w to about 60% w/w imazamox; and
(d) from about 1% w/w to about 30% w/w at least one agrochemically acceptable excipient.

In one embodiment, the present disclosure provides a herbicidal composition comprising:
(a) from about 1% w/w to about 60% w/w mesotrione;
(b) from about 01% w/w to about 60% w/w pendimethalin;
(c) from about 1% w/w to about 60% w/w rimsulfuron; and
(d) from about 1% w/w to about 30% w/w at least one agrochemically acceptable excipient.

In one embodiment, the present disclosure provides a herbicidal composition comprising:
(a) from about 1% w/w to about 50% w/w mesotrione;
(b) from about 1% w/w to about 50% w/w pendimethalin;
(c) from about 1% w/w to about 50% w/w imazamox; and
(d) from about 1% w/w to about 30% w/w at least one agrochemically acceptable excipient.

In one embodiment, the present disclosure provides a herbicidal composition comprising:
(a) from about 1% w/w to about 50% w/w mesotrione;
(b) from about 01% w/w to about 50% w/w pendimethalin;
(c) from about 1% w/w to about 50% w/w rimsulfuron; and
(d) from about 1% w/w to about 30% w/w at least one agrochemically acceptable excipient.

In an embodiment, the present disclosure provides a herbicidal combination comprising:
(a) at least one HPPD inhibitor herbicide;
(b) at least one microtubule assembly inhibitor herbicide; and
(c) at least one AHAS inhibitor herbicide;
wherein the herbicidal combination is present in a form of a liquid formulation.

In an embodiment, the present disclosure provides a herbicidal combination comprising:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof;
wherein the herbicidal combination is present in a form of a liquid formulation

In an embodiment, the herbicidal combination is selected from Capsule suspension (CS), Dispersible concentrate (DC), Emulsion, water in oil (EO), Emulsion, oil in water (EW), Oil dispersion (OD), Oil miscible flowable concentrate (oil miscible suspension (OF), Oil miscible liquid (OL), Suspension concentrate (SC), soluble concentrate (SL) or Suspo-emulsion (SE).

According to an embodiment, the present disclosure provides a liquid formulation comprising:
(a) at least one HPPD inhibitor herbicide;
(b) at least one microtubule assembly inhibitor herbicide; and
(c) at least one AHAS inhibitor herbicide.

In an embodiment, the present disclosure provides a liquid formulation comprising:
(a) at least one HPPD inhibitor herbicide comprising A (1) to A (14) or a combination thereof;
(b) at least one microtubule assembly inhibitor herbicide comprising B (1) to B (18) or a combination thereof; and
(c) at least one AHAS inhibitor herbicide comprising C (1) to C (58) or a combination thereof.

In another embodiment, the present disclosure provides a liquid formulation comprising any of the 870 combinations identified in Table 4.

In one embodiment, the present disclosure provides a liquid formulation comprising:
(a) mesotrione;
(b) pendimethalin; and
(c) imazamox.

In one embodiment, the present disclosure provides a liquid formulation comprising:
(a) mesotrione;
(b) pendimethalin; and
(c) rimsulfuron.

According to an embodiment, the present disclosure provides a liquid formulation comprising:
(a) at least one HPPD inhibitor herbicide;
(b) at least one microtubule assembly inhibitor herbicide;
(c) at least one AHAS inhibitor herbicide; and
(d) at least one agrochemically acceptable excipient.

In an embodiment, the present disclosure provides a liquid formulation comprising:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof; and
(d) at least one agrochemically acceptable excipient.

In one embodiment, the present disclosure provides a liquid formulation comprising:
(a) mesotrione;
(b) pendimethalin;
(c) imazamox; and
(d) at least one agrochemically acceptable excipient.

In one embodiment, the present disclosure provides a liquid formulation comprising:
(a) mesotrione;
(b) pendimethalin;
(c) rimsulfuron; and
(d) at least one agrochemically acceptable excipient.

According to an embodiment, the present disclosure provides a liquid formulation comprising:
(a) at least one HPPD inhibitor herbicide;
(b) at least one microtubule assembly inhibitor herbicide; and
(c) at least one AHAS inhibitor herbicide;
wherein the liquid formulation is either in the form of a tank mix or a pre-formulated (pre-mix)/ready-mix formulation.

According to an embodiment, the present disclosure provides a liquid formulation comprising:
(a) at least one HPPD inhibitor herbicide;
(b) at least one microtubule assembly inhibitor herbicide; and
(c) at least one AHAS inhibitor herbicide;
wherein the liquid formulation is in the form of a tank mix formulation.

According to an embodiment, the present disclosure provides a liquid formulation comprising:
(a) at least one HPPD inhibitor herbicide;
(b) at least one microtubule assembly inhibitor herbicide; and
(c) at least one AHAS inhibitor herbicide;
wherein the liquid formulation is in the form of a pre-formulated (pre-mix)/ready-mix formulation.

In an embodiment, the present disclosure provides a liquid formulation comprising:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof;
wherein the liquid formulation is either in the form of a tank mix or a pre-formulated (pre-mix)/ready-mix formulation.

In an embodiment, the present disclosure provides a liquid formulation comprising:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof;
wherein the liquid formulation is in the form of a tank mix formulation.

In an embodiment, the present disclosure provides a liquid formulation comprising:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof;
wherein the liquid formulation is in the form of a pre-formulated (pre-mix)/ready-mix formulation.

According to an embodiment, the present disclosure provides a liquid formulation comprising:
(a) mesotrione;
(b) pendimethalin; and
(c) imazamox;
wherein the liquid formulation is in the form of a tank mix formulation.

According to an embodiment, the present disclosure provides a liquid formulation comprising:
(a) mesotrione;
(b) pendimethalin; and
(c) imazamox;
wherein the liquid formulation is in the form of a pre-formulated (pre-mix)/ready-mix formulation.

According to an embodiment, the present disclosure provides a liquid formulation comprising:
(a) mesotrione;
(b) pendimethalin; and
(c) rimsulfuron;
wherein the liquid formulation is in the form of a tank mix formulation.

According to an embodiment, the present disclosure provides a liquid formulation comprising:
(a) mesotrione;
(b) pendimethalin; and
(c) rimsulfuron;
wherein the liquid formulation is in the form of a pre-formulated (pre-mix)/ready-mix formulation.

According to an embodiment, the present disclosure provides a tank-mix herbicidal combination comprising:
(a) at least one HPPD inhibitor herbicide;
(b) at least one microtubule assembly inhibitor herbicide; and
(c) at least one AHAS inhibitor herbicide.

In an embodiment, the present disclosure provides a tank-mix herbicidal combination comprising:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof.

In another embodiment, the present disclosure provides a tank-mix herbicidal combination comprising any of the 870 combinations identified in Table 4.

According to an embodiment, the present disclosure provides a tank-mix herbicidal combination comprising:
(a) mesotrione;
(b) pendimethalin; and
(c) imazamox.

According to an embodiment, the present disclosure provides a tank-mix herbicidal combination comprising:
(a) mesotrione;
(b) pendimethalin; and
(c) rimsulfuron.

According to an embodiment, the present disclosure provides a tank-mix herbicidal composition comprising:
(a) at least one HPPD inhibitor herbicide;
(b) at least one microtubule assembly inhibitor herbicide;
(c) at least one AHAS inhibitor herbicide; and
(d) at least one agrochemically acceptable excipient.

In an embodiment, the present disclosure provides a tank-mix herbicidal composition comprising:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof; and
(d) at least one agrochemically acceptable excipient.

According to an embodiment, the present disclosure provides a tank-mix herbicidal composition comprising:
(a) mesotrione;
(b) pendimethalin;
(c) imazamox;
(d) at least one agrochemically acceptable excipient.

According to an embodiment, the present disclosure provides a tank-mix herbicidal composition comprising:
(a) mesotrione;
(b) pendimethalin;
(c) rimsulfuron;
(d) at least one agrochemically acceptable excipient.

According to an embodiment, the tank-mix herbicidal combination is applied pre-emergence or post-emergence for the control of weeds in plants.

According to an embodiment, the tank-mix herbicidal combination is applied pre-emergence for the control of weeds in plants.

According to an embodiment, the tank-mix herbicidal combination is applied post-emergence for the control of weeds in plants.

According to an embodiment, the present disclosure provides a tank-mix herbicidal combination comprising:
(a) mesotrione;
(b) pendimethalin;
(c) imazamox;
wherein the tank-mix herbicidal composition is applied pre-emergence.

According to an embodiment, the present disclosure provides a tank-mix herbicidal combination comprising:
(a) mesotrione;
(b) pendimethalin;
(c) rimsulfuron;
wherein the tank-mix herbicidal composition is applied pre-emergence.

According to an embodiment, the tank-mix herbicidal composition is applied pre-emergence or post-emergence for the control of weeds in plants.

According to an embodiment, the tank-mix herbicidal composition is applied pre-emergence for the control of weeds in plants.

According to an embodiment, the tank-mix herbicidal composition is applied post-emergence for the control of weeds in plants.

According to an embodiment, the present disclosure provides a tank-mix herbicidal composition comprising:
(a) mesotrione;
(b) pendimethalin;
(c) imazamox;
wherein the tank-mix herbicidal composition is applied pre-emergence.

According to an embodiment, the present disclosure provides a tank-mix herbicidal composition comprising:
(a) mesotrione;
(b) pendimethalin;
(c) rimsulfuron;
wherein the tank-mix herbicidal composition is applied pre-emergence.

In another embodiment, the present disclosure provides a process for the preparation of the herbicidal combination, wherein the herbicidal combination comprises:
(a) at least one HPPD inhibitor herbicide;
(b) at least one microtubule assembly inhibitor herbicide; and
(c) at least one AHAS inhibitor herbicide.

In an embodiment, the present disclosure provides a process for the preparation of the herbicidal combination, wherein the herbicidal combination comprises:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof.

In another embodiment, the present disclosure provides a process for the preparation of the herbicidal combination comprising any of the 870 combinations identified in Table 4.

According to an embodiment, the present disclosure provides a process for the preparation of the herbicidal combination, wherein the herbicidal combination comprises:
(a) mesotrione;
(b) pendimethalin; and
(c) imazamox.

According to an embodiment, the present disclosure provides a process for the preparation of the herbicidal combination, wherein the herbicidal combination comprises:
(a) mesotrione;
(b) pendimethalin; and
(c) rimsulfuron.

In another embodiment, the present disclosure provides a process for the preparation of a stable tank-mix herbicidal combination, wherein the stable tank-mix herbicidal combination comprises:
(a) at least one HPPD inhibitor herbicide;
(b) at least one microtubule assembly inhibitor herbicide; and
(c) at least one AHAS inhibitor herbicide.

In an embodiment, the present disclosure provides a process for the preparation of a stable tank-mix herbicidal combination, wherein the stable tank-mix herbicidal combination comprises:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof.

According to an embodiment, the present disclosure provides a process for the preparation of a stable tank-mix herbicidal combination, wherein the stable tank-mix herbicidal combination comprises:
(a) mesotrione;
(b) pendimethalin; and
(c) imazamox.

According to an embodiment, the present disclosure provides a process for the preparation of a stable tank-mix herbicidal combination, wherein the stable tank-mix herbicidal combination comprises:
(a) mesotrione;
(b) pendimethalin; and
(c) rimsulfuron.

According to an embodiment, the process for preparation of the herbicidal combination comprises:

adding at least one HPPD inhibitor herbicide, at least one microtubule assembly inhibitor herbicide, and at least one AHAS inhibitor herbicide to obtain the herbicidal combination.

According to an embodiment, the process for preparation of the herbicidal combination comprises adding mesotrione, pendimethalin, and imazamox to obtain the herbicidal combination.

According to an embodiment, the process for preparation of the herbicidal combination comprises adding mesotrione, pendimethalin and rimsulfuron to obtain the herbicidal combination.

According to an embodiment, the process for preparation of the herbicidal composition comprises adding at least one HPPD inhibitor herbicide, at least one microtubule assembly inhibitor herbicide, at least one AHAS inhibitor herbicide, and at least one agrochemically acceptable excipient to obtain the herbicidal composition.

According to an embodiment, the process for preparation of the herbicidal composition comprises adding mesotrione, pendimethalin and imazamox, and optionally at least one agrochemically acceptable excipient to obtain the herbicidal composition.

According to an embodiment, the process for preparation of the herbicidal composition comprises adding mesotrione, pendimethalin and rimsulfuron, and optionally at least one agrochemically acceptable excipient to obtain the herbicidal composition.

In another embodiment, the present disclosure provides use of the herbicidal combination for controlling growth of weeds in plants, wherein the herbicidal combination comprises:
(a) at least one HPPD inhibitor herbicide;
(b) at least one microtubule assembly inhibitor herbicide; and
(c) at least one AHAS inhibitor herbicide.

In an embodiment, the present disclosure provides use of the herbicidal combination for controlling growth of weeds in plants, wherein the herbicidal combination comprises:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof.

In another embodiment, the present disclosure provides use of the herbicidal combination for controlling growth of weeds in plants comprising any of the 870 combinations identified in Table 4.

In another embodiment, the present disclosure provides use of the herbicidal combination for overcoming resistance of weeds, wherein the herbicidal combination comprises:
(a) at least one HPPD inhibitor herbicide;
(b) at least one microtubule assembly inhibitor herbicide; and
(c) at least one AHAS inhibitor herbicide.

In an embodiment, the present disclosure provides use of the herbicidal combination for overcoming resistance of weeds, wherein the herbicidal combination comprises:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof.

In another embodiment, the present disclosure provides use of the herbicidal combination for overcoming resistance of weeds comprising any of the 870 combinations identified in Table 4.

In another embodiment, the present disclosure provides use of the herbicidal combination for reducing phytotoxicity in plants, wherein the herbicidal combination comprises:
(a) at least one HPPD inhibitor herbicide;
(b) at least one microtubule assembly inhibitor herbicide; and
(c) at least one AHAS inhibitor herbicide.

In an embodiment, the present disclosure provides use of the herbicidal combination for reducing phytotoxicity in plants, wherein the herbicidal combination comprises:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof.

In another embodiment, the present disclosure provides use of the herbicidal combination for reducing phytotoxicity in plants comprising any of the 870 combinations identified in Table 4.

In another embodiment, the present disclosure provides use of the herbicidal combination for controlling growth of weeds in plants, wherein the herbicidal combination comprises:
(a) mesotrione;
(b) pendimethalin; and
(c) imazamox.

In another embodiment, the present disclosure provides use of the herbicidal combination for controlling growth of weeds in plants, wherein the herbicidal combination comprises:
(a) mesotrione;
(b) pendimethalin; and
(c) rimsulfuron.

In another embodiment, the present disclosure provides use of the herbicidal combination for overcoming resistance of weeds, wherein the herbicidal combination comprises:
(a) mesotrione;
(b) pendimethalin; and
(c) imazamox.

In another embodiment, the present disclosure provides use of the herbicidal combination for overcoming resistance of weeds, wherein the herbicidal combination comprises:
(a) mesotrione;
(b) pendimethalin; and
(c) rimsulfuron.

In another embodiment, the present disclosure provides use of the herbicidal combination for reducing phytotoxicity in plants, wherein the herbicidal combination comprises:
(a) mesotrione;
(b) pendimethalin; and
(c) imazamox.

In another embodiment, the present disclosure provides use of the herbicidal combination for reducing phytotoxicity in plants, wherein the herbicidal combination comprises:
(a) mesotrione;
(b) pendimethalin; and
(c) rimsulfuron.

In another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, to a plant or a locus thereof.

In another embodiment, the present disclosure provides a method for controlling weeds in plants, the method comprising applying to a plant or to a locus thereof a herbicidal combination comprising:
(a) at least one HPPD inhibitor herbicide;
(b) at least one microtubule assembly inhibitor herbicide; and
(c) at least one AHAS inhibitor herbicide.

In yet another embodiment, the present disclosure provides a method for controlling weeds in plants, the method comprising applying to a plant or to a locus thereof a herbicidal combination comprising:
(a) at least one HPPD inhibitor herbicide comprising A (1) to A (14) or a combination thereof;
(b) at least one microtubule assembly inhibitor herbicide comprising B (1) to B (18) or a combination thereof; and
(c) at least one AHAS inhibitor herbicide comprising C (1) to C (58) or a combination thereof.

In an embodiment, present disclosure provides a method for controlling growth of weeds in plants by using a herbicidal combination comprising any of the 870 combinations identified in Table 4.

In another embodiment, the present disclosure provides a method for controlling growth of weeds in plants, the method comprising applying to a plant or to a locus thereof the herbicidal combination comprising:
(a) mesotrione;
(b) pendimethalin; and
(c) imazamox.

In another embodiment, the present disclosure provides a method for controlling growth of weeds in plants, the method comprising applying to a plant or to a locus thereof the herbicidal combination comprising:
(a) mesotrione;
(b) pendimethalin; and
(c) rimsulfuron.

In another embodiment, the present disclosure provides a method for overcoming resistance of weeds, the method comprising applying to a plant or to a locus thereof a herbicidal combination comprising:
(a) at least one HPPD inhibitor herbicide;
(b) at least one microtubule assembly inhibitor herbicide; and
(c) at least one AHAS inhibitor herbicide.

In an embodiment, the present disclosure provides a method for overcoming resistance of weeds, the method comprising applying a herbicidal combination comprising:
(a) at least HPPD inhibitor comprising A (1) to A (14) or a combination thereof;
(b) at least one microtubule assembly inhibitor comprising B (1) to B (18) or a combination thereof; and
(c) at least one AHAS inhibitor comprising C (1) to B (58) or a combination thereof.

In an embodiment, present disclosure provides a method for overcoming resistance of weeds by using a herbicidal combination comprising any of the 870 combinations identified in Table 4.

In another embodiment, the present disclosure provides a method for overcoming resistance of weeds, the method comprising applying to a plant or to a locus thereof the herbicidal combination comprising:
(a) mesotrione;
(b) pendimethalin; and
(c) imazamox.

In another embodiment, the present disclosure provides a method for overcoming resistance of weeds, the method comprising applying to a plant or to a locus thereof the herbicidal combination comprising:
(a) mesotrione;
(b) pendimethalin; and
(c) rimsulfuron.

In another embodiment, the present disclosure provides a method for reducing phytotoxicity in plants, the method comprising applying to a plant or to a locus thereof a herbicidal combination comprising:
(a) at least one HPPD inhibitor herbicide;
(b) at least one microtubule assembly inhibitor herbicide; and
(c) at least one AHAS inhibitor herbicide.

In an embodiment, the present disclosure provides a method for reducing phytotoxicity in plants, the method comprising applying to a plant or to a locus thereof a herbicidal combination comprising:
(a) at least HPPD inhibitor comprising A (1) to A (14) or a combination thereof;
(b) at least one microtubule assembly inhibitor comprising B (1) to B (18) or a combination thereof; and
(c) at least one AHAS inhibitor comprising C (1) to B (58) or a combination thereof.

In an embodiment, present disclosure provides a method for reducing phytotoxicity in plants by using a herbicidal combination comprising any of the 870 combinations identified in Table 4.

In another embodiment, the present disclosure provides a method for reducing phytotoxicity in plants, the method comprising applying to a plant or to a locus thereof the herbicidal combination comprising:
(a) mesotrione;
(b) pendimethalin; and
(c) imazamox.

In another embodiment, the present disclosure provides a method for reducing phytotoxicity in plants, the method comprising applying to a plant or to a locus thereof the herbicidal combination comprising:
(a) mesotrione;
(b) pendimethalin; and
(c) rimsulfuron.

In an embodiment, the herbicidal combination comprising at least one HPPD inhibitor, at least one microtubule assembly inhibitor, and at least one AHAS inhibitor, is used to control weeds in plants, by applying to the plants or to the locus thereof of tree fruits, nuts and vines (TNV) crops.

In an embodiment, the herbicidal combination comprising at least HPPD inhibitor, at least one microtubule assembly inhibitor, and at least one AHAS inhibitor is used to control weeds in the locus of TNV crops including, but not limited to, pomefruits, stonefruits, citrus, nut crops, vine crops, currants & gooseberries, and berry crops.

In an embodiment, the herbicidal combination comprising at least HPPD inhibitor, such as mesotrione, at least one microtubule assembly inhibitor, such as pendimethalin, and at least one AHAS inhibitor such as imazamox, is used to control weeds in the locus of TNV crops including but not limited to pomefruits, stonefruits, citrus, nut crops, vine crops, currants & gooseberries, and berry crops.

In an embodiment, the herbicidal combination comprising at least HPPD inhibitor, such as mesotrione, at least one microtubule assembly inhibitor, preferably pendimethalin, and at least one AHAS inhibitor such as rimsulfuron, is used to control weeds in the locus of TNV crops including but not limited to pomefruits, stonefruits, citrus, nut crops, vine crops, currants & gooseberries, and berry crops.

In an embodiment, the TNV crops are pomefruits comprising one or more of apple, pear, nashi (Asian Pear), loquat (Japanese Medlar), pomegranate, and quince.

In an embodiment, the TNV crops are stonefruits comprising one or more of apricot, cherry, peach, necatarine p., peacharine p., plum, prune p., and plumcot/pluott p.

In an embodiment, the TNV crops are citrus fruits comprising one or more of grapefruit, kumquat (cumquat), lemon, lime, orange (sweet), orange (blood), pumelo (shaddock), tangarine (mandarin), tangelo c., and tangor c. In an embodiment, the TNV crops are one or more of persimmon (Oriental), persimmon (American) and fig. In an embodiment, the TNV crops are one or more of avacado, banana, carob, guava, strawberry, tropical, cherry, Feijoa mango, olive, and tamarillo (Tree Tomato).

In an embodiment, the TNV crops are nut crops comprising one or more of chestnut, hazelnut, pecan, walnut, cashew, macadamia, pistachio, pine nuts, bunya pine, quandong and sandalwood.

In an embodiment, the TNV crops are vine crops comprising one or more of grape, kiwi (chinese gooseberry), passionfruit, banana passionfruit, granadillas passiflora spp., and giant granadilla.

In an embodiment, the TNV crops are one or more of currants & gooseberries crops comprising black currants, red currant, white currant, Cape gooseberry, English gooseberry and mulberry.

In an embodiment, the berry crops are one or more of berry crops comprising blueberry, elderberry, blackberry, brambleberry, raspberry and strawberry.

In an embodiment, the TNV crops are one or more of the annonas, babaco, blackberry tree, black persimmon, Barbados cherry (Acerola), Brazilian cherry, Brazilian tree grape (Jaboticaba), black tropical cherry, capulin, cherry (tropical cherry), carambola (star fruit), casimora, Ceylon Hill cherry, Chilean guava (tazzie berry), coconut, cordia, date palm, grumichama, jujube (Chinese date), jujube, lilly pilly, lime berry, litchee, longan, malay almond, miracle fruit, monstera, natal plum, nonda, panama berry, papaya, pithaya, prickly pear, pepino, sapodilla, sapote, star apple, strawberry tree (Irish), rollina, tamarind tree, and wampee (Wampi).

In an embodiment, some of the weeds affecting the TNV crops are Poa annua, Hordeum murinum, Conyza canadensis, Portulaca oleracea, Cynodon dactylon, Sorghum halepense, Carduus acanthoides, Amaranthus retroflexus, Cirsium arvense, Chenopodium album, Solanum nigrum, Asparagus officinalis, Echinochloa crus-galli, Convolvulus arvensis, Rubus spp., Bromus spp., Medicago polymorpha, Phalaris canariensis, Hypochaeris radicata, Stellaria media, Trifolium repens, Xanthium spp., Digitaria spp., Gnaphalium spp., Paspalum dilatatum, Taraxacum officinale, Rumex crispus and Festuca rubra.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the HPPD inhibitor herbicide is applied in a range from about 10 to about 400 g a.i./ha.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the HPPD inhibitor herbicide is applied in a range from about 50 to about 350 g a.i./ha.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the HPPD inhibitor herbicide is applied in a range of from about 100 to about 300 g a.i./ha.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the HPPD inhibitor herbicide is applied in a range of about 210 g a.i./ha.

In yet another embodiment, the present disclosure provides a method for controlling growth of weeds in plants, the method comprising applying a herbicidal combination comprising mesotrione, pendimethalin, and imazamox, wherein mesotrione is applied in a range of about 210 g a.i./ha.

In yet another embodiment, the present disclosure provides a method for controlling growth of weeds in plants, the method comprising applying a herbicidal combination comprising mesotrione, pendimethalin, and rimsulfuron, wherein mesotrione is applied in a range of about 210 g a.i./ha.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the microtubule assembly inhibitor herbicide is applied in a range from about 500 to about 7000 g a.i./ha.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the microtubule assembly inhibitor herbicide is applied in a range from about 1000 to about 6000 g a.i./ha.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the microtubule assembly inhibitor herbicide is applied in a range from about 2000 to about 5000 g a.i./ha.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the microtubule assembly inhibitor herbicide is applied in a range of about 4270 g ai./ha

In yet another embodiment, the present disclosure provides a method for controlling growth of weeds in plants, the method comprising applying a herbicidal combination comprising mesotrione, pendimethalin, and imazamox, wherein pendimethalin is applied in a range of about 4270 g a.i./ha.

In yet another embodiment, the present disclosure provides a method for controlling growth of weeds in plants, the method comprising applying a herbicidal combination comprising mesotrione, pendimethalin, and rimsulfuron, wherein pendimethalin is applied in a range of about 4270 g a.i./ha.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the AHAS inhibitor herbicide is applied in a range from about 10 to about 500 g a.i./ha.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the AHAS inhibitor herbicide is applied in a range from about 10 to about 400 g a.i./ha.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the AHAS inhibitor herbicide is applied in a range from about 20 to about 200 g a.i./ha.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the AHAS inhibitor herbicide is applied in a range of about 105 g a.i./ha.

In yet another embodiment, the present disclosure provides a method for controlling growth of weeds in plants, the method comprising applying a herbicidal combination comprising mesotrione, pendimethalin, and imazamox, wherein imazamox is applied in a range of about 105 g a.i./ha.

In yet another embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the AHAS inhibitor herbicide is applied in a range of about 70 g a.i./ha.

In yet another embodiment, the present disclosure provides a method for controlling growth of weeds in plants, the method comprising applying a herbicidal combination comprising mesotrione, pendimethalin, and rimsulfuron, wherein rimsulfuron is applied in a range of about 70 g a.i./ha.

According to an embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range from about 10 to about 5000 g/Ha.

In one embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range from about 50 to about 4000 g/Ha.

In one embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range from about 100 to about 3000 g/Ha.

In one embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range from about 100 to about 2500 g/Ha.

In one embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range from about 100 to about 2000 g/Ha.

According to an embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range from about 1 to about 300 gal/acre.

In one embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range from about 10 to about 200 gal/acre.

In one embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range from about 10 to about 100 gal/acre.

In one embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range of about 20 gal/acre.

In one embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range of about 25 gal/acre.

According to an embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range from about 1 to about 500 L/ha.

In one embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range from about 10 to about 400 L/ha.

In one embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range from about 10 to about 300 L/ha.

In one embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range of about 233 L/ha.

In one embodiment, the present disclosure provides a method for controlling growth of weeds in plants, the method comprising applying a herbicidal combination comprising at least one HPPD inhibitor herbicide, at least one microtubule assembly inhibitor herbicide, and at least one AHAS inhibitor herbicide, wherein the herbicidal combination is applied in a range of about 187 L/ha.

According to an embodiment of the present disclosure, the various components of the herbicidal combination can be used individually or already partially or completely mixed with one at least one other to prepare the herbicidal combination according to the disclosure. It is also possible for them to be packaged and used further as a composition such as a kit of parts.

The disclosure also provides a kit comprising the herbicidal combination for the controlling growth of weeds, overcoming resistance of weeds and controlling phytotoxicity in plants and instructions for use. The instructions for use typically comprise instructions for the application of the herbicidal combination to the plant or to a locus thereof.

According to an embodiment, the present disclosure provides a kit of parts comprising at least one HPPD inhibitor herbicide; at least one microtubule assembly inhibitor herbicide; and at least one AHAS inhibitor herbicide; wherein a first container contains the HPPD inhibitor herbicide, a second container contains the microtubule assembly inhibitor herbicide, and a third container contains the AHAS inhibitor herbicide.

In an embodiment, the present disclosure provides a kit of parts comprising (a) at least HPPD inhibitor comprising A (1) to A (14) or a combination thereof; (b) at least one microtubule assembly inhibitor comprising B (1) to B (18) or a combination thereof; and (c) at least one AHAS inhibitor comprising C (1) to B (58) or a combination thereof; wherein a first container contains the HPPD inhibitor herbicide comprising A (1) to A (14) or a combination thereof, a second container contains the microtubule assembly inhibitor herbicide B (1) to B (18) or a combination thereof, and a third container contains the AHAS inhibitor herbicide comprising C (1) to B (58) or a combination thereof.

In an embodiment, present disclosure provides a kit of parts comprising any of the 870 combinations identified in Table 4.

According to an embodiment, the present disclosure provides a kit of parts comprising mesotrione; pendimethalin; and imazamox; wherein a first container contains mesotrione, a second container contains pendimethalin, and a third container contains imazamox.

According to an embodiment, the present disclosure provides a kit of parts comprising mesotrione; pendimethalin; and rimsulfuron; wherein a first container contains mesotrione, a second container contains pendimethalin, and a third container contains rimsulfuron.

According to an embodiment, the kit of parts comprises:
(a) at least one HPPD inhibitor herbicide;
(b) at least one microtubule assembly inhibitor herbicide;
(c) at least one AHAS inhibitor herbicide;
and optionally further comprises:
(d) instructions for use.

According to an embodiment, the kit of parts comprises:
(a) at least one HPPD inhibitor herbicide comprising A (1) to A (14) or a combination thereof;
(b) at least one microtubule assembly inhibitor herbicide comprising B (1) to A (18) or a combination thereof;
(c) at least one AHAS inhibitor herbicide comprising C (1) to C (58) or a combination thereof;
and optionally further comprises:
(d) instructions for use.

According to an embodiment, the kit of parts comprises:
(a) mesotrione;
(b) pendimethalin;
(c) imazamox;
and optionally further comprises:
(d) instructions for use.

According to an embodiment, the kit of parts comprises:
(a) mesotrione;
(b) pendimethalin;
(c) rimsulfuron;
and optionally further comprises:
(d) instructions for use.

Typically, the instructions for use comprise instructions directing a user to mix the components of the kit before application of the components of the kit to the plant or to a locus thereof.

Often, the components of the kit are packaged separately. However, the disclosure is not limited to kits in which the components are packaged separately. For example, the HPPD inhibitor herbicide, the microtubule assembly inhibitor herbicide, and the AHAS inhibitor herbicide may be packaged together or formulated together.

In embodiments of the kit of the disclosure in which the HPPD inhibitor herbicide, the microtubule assembly inhibitor herbicide, and the AHAS inhibitor herbicide are packaged separately, may be tank mixed before being administered to the plant or to a locus thereof. Typically, such an administration to the plant or to a locus thereof is by spraying the tank-mixed formulation.

In one embodiment of the disclosure, the kit may include one or more, including all, components that may be used to prepare the herbicidal combination, e.g., kits may include active ingredients and/or excipients. One or more of the components may already be combined together or pre-formulated. In those embodiments where more than two components are provided in a kit, the components may already be combined together and as such are packaged in a single container such as a vial, bottle, can, pouch, bag or canister. In other embodiments, two or more components of a kit may be packaged separately, i.e., not pre-formulated. As such, kits may include one or more separate containers such as vials, cans, bottles, pouches, bags or canisters, each container containing a separate component for herbicidal combination.

According to an embodiment of the disclosure, the kit may include one or more, including all, components that may be used to prepare a stable tank-mix formulation, e.g., the kit may include a HPPD inhibitor herbicide, a microtubule assembly inhibitor herbicide, and a AHAS inhibitor herbicide.

In both forms, a component of the kit may be applied separately from or together with the further components or as a component of a combination according to the disclosure for preparing the herbicidal combination according to the disclosure.

In an embodiment of the present disclosure, the herbicidal combination comprises (a) the HPPD inhibitor herbicide; (b) the microtubule assembly inhibitor herbicide; and (c) the AHAS inhibitor herbicide in the form of a kit with single pack or multi pack.

In an embodiment of the present disclosure, the herbicidal combination comprises (a) mesotrione; (b) pendimethalin; and (c) imazamox in the form of a kit with single pack or multi pack.

In an embodiment of the present disclosure, the herbicidal combination comprises (a) mesotrione; (b) pendimethalin; and (c) rimsulfuron in the form of a kit with single pack or multi pack.

In an embodiment of the present disclosure, the herbicidal combination comprises (a) mesotrione; (b) pendimethalin; and (c) imazamox in the form of a kit with multi packs.

In an embodiment of the present disclosure, the herbicidal combination comprises (a) mesotrione; (b) pendimethalin; and (c) rimsulfuron in the form of a kit with multi packs.

According to an embodiment of the present disclosure, a kit comprising a combination of (a) HPPD inhibitor herbicide; (b) microtubule assembly inhibitor herbicide; and (c) AHAS inhibitor herbicide is used for preparing a stable tank-mix formulation.

According to an embodiment of the present disclosure, a kit comprising a combination (a) mesotrione; (b) pendimethalin; and (c) imazamox is used for preparing a stable tank-mix formulation.

According to an embodiment of the present disclosure, a kit comprising a combination (a) mesotrione; (b) pendimethalin; and (c) rimsulfuron is used for preparing a stable tank-mix formulation.

According to an embodiment of the present disclosure, a kit comprising a combination of (a) HPPD inhibitor herbicide; (b) microtubule assembly inhibitor herbicide; and (c) AHAS inhibitor herbicide is used for preparing a stable pre-mix formulation.

According to an embodiment of the present disclosure, a kit comprising a combination (a) mesotrione; (b) pendimethalin; and (c) imazamox is used for preparing a stable pre-mix formulation.

According to an embodiment of the present disclosure, a kit comprising a combination (a) mesotrione; (b) pendimethalin; and (c) rimsulfuron is used for preparing a stable pre-mix formulation.

In another embodiment, the herbicidal combination described above is stable, over time and at various temperatures.

In yet another embodiment, whether a combination is synergistic or not is synergistic is determined by comparison of observed efficacy of the herbicidal combination to that of expected efficacy of the herbicidal combination. This is calculated by Colby’s Equation.

Consider X and Y as observed efficacies of A and B, respectively. The Colby’s equation as disclosed below, provides expected efficacies of the combination:

$$\text{E = X + Y -} \text{XY} / 100$$

Similarly, consider X, Y, and Z as observed efficacies of A, B, and C respectively. The Colby’s equation as disclosed below provides expected efficacies of the triple combination.

$$\text{E= X + Y + Z -} \text{XY} / 100 \text{-} \text{XZ} / 100 \text{-} \text{YZ} / 100 \text{+} \text{XYZ} / 10000 .$$

In an embodiment, the present disclosure provides a synergistic agrochemical combination.

Accordingly in an embodiment, the present disclosure provides a synergistic herbicidal combination.

In another embodiment, the present disclosure provides a synergistic herbicidal combination comprising:
(a) at least one HPPD inhibitor herbicide;
(b) at least one microtubule assembly inhibitor herbicide; and
(c) at least one AHAS inhibitor herbicide.

In an embodiment, the present disclosure provides a synergistic herbicidal combination comprising:
(a) at least one HPPD inhibitor herbicide comprising A (1) to A (14) or a combination thereof;
(b) at least one microtubule assembly inhibitor herbicide comprising B (1) to B (18) or a combination thereof; and
(c) at least one AHAS inhibitor herbicide comprising C (1) to C (58) or a combination thereof.

In one embodiment, the present disclosure provides a synergistic herbicidal combination comprising:
(a) mesotrione;
(b) pendimethalin; and
(c) imazamox.

In one embodiment, the present disclosure provides a synergistic herbicidal combination comprising:
(a) mesotrione;
(b) pendimethalin; and
(c) rimsulfuron.

In another embodiment, the present disclosure provides a synergistic herbicidal combination comprising any of the 870 combinations identified in Table 4. In an embodiment, the present disclosure provides a synergistic herbicidal composition comprising:
(a) at least one HPPD inhibitor herbicide;
(b) at least one microtubule assembly inhibitor herbicide;
(c) at least one AHAS inhibitor herbicide; and
(d) at least one agrochemically acceptable excipient.

In an embodiment, the present disclosure provides a synergistic herbicidal composition comprising:
(a) at least one HPPD inhibitor herbicide comprising A (1) to A (14) or a combination thereof;
(b) at least one microtubule assembly inhibitor herbicide comprising B (1) to B (18) or a combination thereof;
(c) at least one AHAS inhibitor herbicide comprising C (1) to C (58) or a combination thereof; and
(d) at least one agrochemically acceptable excipient.

In another embodiment, the present disclosure provides a synergistic herbicidal composition comprising any of the 870 combinations identified in Table 4.

In one embodiment, the present disclosure provides a synergistic herbicidal composition comprising:
(a) mesotrione;
(b) pendimethalin;
(c) imazamox; and
(d) at least one agrochemically acceptable excipient.

In one embodiment, the present disclosure provides a synergistic herbicidal composition comprising:
(a) mesotrione;
(b) pendimethalin;
(c) rimsulfuron; and
(d) at least one agrochemically acceptable excipient.

It is another objective of the present disclosure to provide use of a synergistic herbicidal combination comprising at least one HPPD inhibitor herbicide, at least one microtubule assembly inhibitor herbicide and at least one AHAS inhibitor herbicide, for the control of weeds in plants.

It is another objective of the present disclosure to provide a process for preparation of a synergistic herbicidal combination, the combination comprising at least one HPPD inhibitor herbicide, at least one microtubule assembly inhibitor herbicide and at least one AHAS inhibitor herbicide.

It is another objective of the present disclosure to provide a method for controlling growth weeds in plants, said method comprising applying a synergistic herbicidal combination to said plant or to a locus thereof.

It is yet another objective of the present disclosure to provide a method for overcoming resistance of weeds in plants, said method comprising applying a synergistic herbicidal combination to said plant or to a locus thereof.

It is yet another objective of the present disclosure to provide a method for reducing phytotoxicity in plants, said method comprising applying a synergistic herbicidal combination to said plant or to a locus thereof.

All the features described herein may be combined with any of the above aspects, in any combination.

In order that the present disclosure may be more readily understood, reference will now be made, by way of example, to the following description. The following examples illustrate the disclosure. They do not, however, limit the disclosure in any way. It will be understood that all tests and physical properties listed have been determined at atmospheric pressure and room temperature (i.e., 25° C.), unless otherwise stated herein, or unless otherwise stated in the referenced test methods and procedures. It will be understood that the specification and examples are illustrative but not limiting of the present disclosure and that other embodiments within the spirit and scope of the disclosure will suggest themselves to those skilled in the art. Other embodiments can be practiced that are also within the scope of the present disclosure.

### EXAMPLES

### Example 1

Experiments were carried out to evaluate the bio-efficacy of the herbicidal combinations according to the present disclosure. The herbicides were applied at the pre-emergence stage. The results have been disclosed in Tables 1-5.

Weeds: Grasses spp., Common Lambsquarters, Redroot Pigweed, Southwestern Cupgrass, Hairy Fleabane

TABLE 1

Bio-efficacy of the herbicidal combinations

| Treatment | Rate (G ai) | Control 29 DAT (%) | | | | |
|---|---|---|---|---|---|---|
| | | Grasses spp. | Common Lambsquarters | Redroot Pigweed | Southwestern Cupgrass | Hairy Fleabane |
| Imazamox | 105 | 97 | 99 | 99 | 100 | 98 |
| Pendimethalin | 4270 | | | | | |
| Mesotrione | 210 | | | | | |
| Rimsulfuron | 70 | 99 | 99 | 99 | 98 | 100 |
| Pendimethalin | 4270 | | | | | |
| Mesotrione | 210 | | | | | |

G ai: Grams active ingredient
29 DAT: 29 days after treatment

Weeds: Redroot Pigweed, Common Mallow, Prostrate Spurge, Annual Sowthistle, Common Lambsquarters

TABLE 2

Bio-efficacy of the herbicidal combinations

| Treatment | Rate (G ai) | Control 29 DAT (%) | | | | |
|---|---|---|---|---|---|---|
| | | Redroot Pigweed | Common Mallow | Prostrate Spurge | Annual Sowthistle | Common Lambsquarters |
| Imazamox | 105 | 100 | 100 | 95 | 100 | 100 |
| Pendimethalin | 4270 | | | | | |
| Mesotrione | 210 | | | | | |
| Rimsulfuron | 70 | 100 | 100 | 100 | 100 | 100 |
| Pendimethalin | 4270 | | | | | |
| Mesotrione | 210 | | | | | |

G ai: Grams active ingredient
29 DAT: 29 days after treatment

Weeds: Wild Radish, Palmer Amaranth, Ivyleaf Morningglory, Large Crabgrass, Sicklepod, Common Cocklebur

TABLE 3

Bio-efficacy of the herbicidal combinations

| Treatment | Rate (G ai) | Control 28 DAT (%) | | | | | |
|---|---|---|---|---|---|---|---|
| | | Wild Radish | Palmer Amaranth | Ivyleaf Morning -glory | Large Crabgrass | Sickle -pod | Common Cocklebur |
| Imazamox | 105 | 97 | 99 | 99 | 99 | 97 | 96 |
| Pendimethalin | 4270 | | | | | | |
| Mesotrione | 210 | | | | | | |
| Rimsulfuron | 70 | 99 | 99 | 99 | 99 | 99 | 96 |
| Pendimethalin | 4270 | | | | | | |
| Mesotrione | 210 | | | | | | |

G ai: Grams active ingredient
28 DAT: 28 days after treatment

Weeds: Giant Foxtail, Common Ragweed, Galinsoga, Yellow Nutsedge

TABLE 4

Bio-efficacy of the herbicidal combinations

| Treatment | Rate (G ai) | Control 27 DAT (%) | | | |
|---|---|---|---|---|---|
| | | Giant Foxtail | Common Ragweed | Galinsoga | Yellow Nutsedge |
| Imazamox | 105 | 98 | 93 | 100 | 73 |
| Pendimethalin | 4270 | | | | |
| Mesotrione | 210 | | | | |
| Rimsulfuron | 70 | 100 | 100 | 100 | 100 |
| Pendimethalin | 4270 | | | | |
| Mesotrione | 210 | | | | |
| Imazamox | 105 | 58 | 63 | 53 | 40 |

G ai: Grams active ingredient
27 DAT: 27 days after treatment

Weeds: Common Velvetgrass, Broadleaf spp., Red Sorrel, Dandelion, Geranium spp.

TABLE 5

Bio-efficacy of the herbicidal combinations

| Treatment | Rate (G ai) | Control 85 DAT (%) | | |
|---|---|---|---|---|
| | | Red Sorrel | Dandelion | Geranium spp. |
| Imazamox | 105 | 58 | 60 | 56 |
| Pendimethalin | 4270 | | | |
| Mesotrione | 210 | | | |
| Rimsulfuron | 70 | 76 | 75 | 73 |
| Pendimethalin | 4270 | | | |
| Mesotrione | 210 | | | |
| Rimsulfuron | 70 | 38 | 43 | 43 |
| Pendimethalin | 4270 | | | |
| Pendimethalin | 4270 | 30 | 33 | 20 |
| Mesotrione | 210 | | | |
| Imazamox | 105 | 10 | 13 | 15 |
| Pendimethalin | 4270 | | | |
| Imazamox | 105 | 13 | 25 | 13 |
| Mesotrione | 210 | | | |
| Imazamox | 105 | 13 | 5 | 8 |
| Rimsulfuron | 70 | 18 | 45 | 28 |
| Pendimethalin | 4270 | 15 | 20 | 18 |
| Mesotrione | 210 | 8 | 8 | 5 |

G ai: Grams active ingredient
85 DAT: 85 days after treatment

### Example 2

Experiments were carried out to evaluate the bio-efficacy of the herbicidal combinations according to the present disclosure. The herbicides were applied at the pre-emergence stage. The results for % ground cover of the weeds has been disclosed in Table 6.

Weeds: Mallow spp., Kochia, Buckwheat spp., Russian Thistle, Nutsedge spp.

TABLE 6

Bio-efficacy of the herbicidal combinations for % ground cover of herbicides

| Treatment | Rate (G ai) | % Ground Cover 33 DAT | | | | |
|---|---|---|---|---|---|---|
| | | Mallow spp. | Kochia | Buckwheat spp. | Russian Thistle | Nutsedge spp. |
| Imazamox | 105 | 0 | 0 | 0 | 0 | 0 |
| Pendimethalin | 4270 | | | | | |
| Mesotrione | 210 | | | | | |
| Rimsulfuron | 70 | 0 | 0 | 0 | 2.5 | 0 |
| Pendimethalin | 4270 | | | | | |
| Mesotrione | 70 | | | | | |

G ai: Grams active ingredient
33 DAT: 33 days after treatment

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. A herbicidal combination comprising:
(a) at least one hydroxyphenyl pyruvate dioxygenase (HPPD) inhibitor herbicide;
(b) at least one microtubule assembly inhibitor herbicide; and
(c) at least one acetohydroxyacid synthase (AHAS) inhibitor herbicide.

2. The combination as claimed in claim 1, wherein the HPPD inhibitor herbicide is selected from the group comprising isoxaflutole, pyrasulfotole, tolpyralate, topramezone, benzofenap, pyrazolynate, pyrazoxyfen, bicyclopyrone, fenquinotrione, mesotrione, sulcotrione, tefuryltrione, tembotrione, benzobicyclon, or combinations thereof.

3. The combination as claimed in claim 2, wherein the HPPD inhibitor herbicide is mesotrione.

4. The combination as claimed in claim 1, wherein the microtubule assembly inhibitor herbicide is selected from the group comprising propyzamide/pronamide, chlorthaldimethyl/DCPA, benefin/benfluralin, butralin, dinitramine, ethalfluralin, fluchloralin, isopropalin, nitralin, oryzalin, pendimethalin, prodiamine, profluralin, trifluralin, butamifos, DMPA, dithiopyr, thiazopyr, or combinations thereof.

5. The combination as claimed in claim 4, wherein the microtubule assembly inhibitor herbicide is pendimethalin.

6. The combination as claimed in claim 1, wherein the AHAS inhibitor herbicide is selected from the group comprising imazamethabenz-methyl, imazamox, imazapic, imazapyr, imazaquin, imazethapyr, bispyribac-sodium, pyribenzoxim (prodrug of bispyribac), pyriftalid, pyriminobac-methyl, pyrithiobac-sodium, pyrimisulfan, triafamone, amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flucetosulfuron, flupyrsulfuron-methyl-sodium, foramsulfuron, halosulfuron-methyl, imazosulfuron, iodosulfuron-methyl-sodium, mesosulfuron-methyl, metazosulfuron, metsulfuron-methyl, nicosulfuron, orthosulfamuron, oxasulfuron, primisulfuron-methyl, propyrisulfuron, prosulfuron, pyrazosulfuron-ethyl, rimsulfuron, sulfometuron-methyl, sulfosulfuron, thifensulfuron-methyl, triasulfuron, tribenuron-methyl, trifloxysulfuron- sodium, triflusulfuron-methyl, tritosulfuron, flucarbazone-sodium, propoxycarbazone-sodium, thiencarbazone-methyl, cloransulam-methyl, diclosulam, florasulam, flumetsulam, metosulam, penoxsulam, pyroxsulam or combinations thereof.

7. The combination as claimed in claim 6, wherein the AHAS inhibitor herbicide is imazamox.

8. The combination as claimed in claim 6, wherein the AHAS inhibitor herbicide is rimsulfuron.

9. The combination as claimed in claim 1, wherein the herbicidal combination is present in a form of a liquid formulation.

10. The combination as claimed in claim 1, wherein the herbicidal combination is present either in a form of a tank mix or a pre-formulated (premix)/ready-mix formulation.

11. A herbicidal combination comprising:
(a) mesotrione;
(b) pendimethalin; and
(c) imazamox.

12. A herbicidal combination comprising:
(a) mesotrione;
(b) pendimethalin; and
(c) rimsulfuron.

13. Use of a herbicidal combination comprising at least one HPPD inhibitor herbicide, at least one microtubule assembly inhibitor herbicide, and at least one AHAS inhibitor herbicide, for controlling growth of weeds in plants.

14. A herbicidal composition comprising:
(a) at least one HPPD inhibitor herbicide;
(b) at least one microtubule assembly inhibitor herbicide;
(c) at least one AHAS inhibitor herbicide; and
(d) at least one agrochemically acceptable excipient.

15. The composition as claimed in claim 14, wherein the HPPD inhibitor herbicide is selected from the group comprising isoxaflutole, pyrasulfotole, tolpyralate, topramezone, benzofenap, pyrazolynate, pyrazoxyfen, bicyclopyrone, fenquinotrione, mesotrione, sulcotrione, tefuryltrione, tembotrione, benzobicyclon, or combinations thereof.

16. The composition as claimed in claim 15, wherein the HPPD inhibitor herbicide is mesotrione.

17. The composition as claimed in claim 14, wherein the microtubule assembly inhibitor herbicide is selected from the group comprising propyzamide/pronamide, chlorthaldimethyl/DCPA, benefin/benfluralin, butralin, dinitramine, ethalfluralin, fluchloralin, isopropalin, nitralin, oryzalin, pendimethalin, prodiamine, profluralin, trifluralin, butamifos, DMPA, dithiopyr, thiazopyr, or combinations thereof.

18. The composition as claimed in claim 17, wherein the microtubule assembly inhibitor herbicide is pendimethalin.

19. The composition as claimed in claim 14, wherein the AHAS inhibitor herbicide is selected from the group comprising imazamethabenz-methyl, imazamox, imazapic, imazapyr, imazaquin, imazethapyr, bispyribac-sodium, pyribenzoxim (prodrug of bispyribac), pyriftalid, pyriminobac-methyl, pyrithiobac-sodium, pyrimisulfan, triafamone, amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flucetosulfuron, flupyrsulfuron-methyl-sodium, foramsulfuron, halosulfuron-methyl, imazosulfuron, iodosulfuron-methyl-sodium, mesosulfuron-methyl, metazosulfuron, metsulfuron-methyl, nicosulfuron, orthosulfamuron, oxasulfuron, primisulfuron-methyl, propyrisulfuron, prosulfuron, pyrazosulfuron-ethyl, rimsulfuron, sulfometuron-methyl, sulfosulfuron, thifensulfuron-methyl, triasulfuron, tribenuron-methyl, trifloxysulfuron-na, triflusulfuron-methyl, tritosulfuron, flucarbazone-sodium, propoxycarbazone-sodium, thiencarbazone-methyl, cloransulam-methyl, diclosulam, florasulam, flumetsulam, metosulam, penoxsulam, pyroxsulam or combinations thereof.

20. The composition as claimed in claim 19, wherein the AHAS inhibitor herbicide is imazamox.

21. The composition as claimed in claim 19, wherein the AHAS inhibitor herbicide is rimsulfuron.

22. The composition as claimed in claim 14, wherein the agrochemically acceptable excipient is selected from one or more of emulsifiers, colorants, thickeners/binders, antifreeze agents, antifoaming agents, antioxidants, solvents, preservatives, glidants, anticaking agents, pH-regulating agents, buffering agents, formulation aids, disintegrants, or combinations thereof.

23. A method for controlling growth of weeds in plants, the method comprising:
applying a herbicidal combination comprising at least one HPPD inhibitor herbicide, at least one microtubule assembly inhibitor herbicide, and at least one AHAS inhibitor herbicide, to a plant or a locus thereof.

24. The method as claimed in claim 23, wherein the method comprises applying a herbicidal combination comprising:
(a) mesotrione;
(b) pendimethalin; and
(c) imazamox.

25. The method as claimed in claim 23, wherein the method comprises applying a herbicidal combination comprising:
(a) mesotrione;
(b) pendimethalin; and
(c) rimsulfuron.

26. The method as claimed in claim 23, wherein the method comprises applying the herbicidal combination in a range from about 10 to about 400 L/ha.
